(19) United States
(12) Patent Application Publication
(10) Pub. No.: US 2014/0254075 A1
(43) Pub. Date: Sep. 11, 2014

(54) INTEGRATING MEDIA DISPLAY INTO COMPUTER PERIPHERALS AND COMPUTING SYSTEMS: THE MEDIA MOUSE, MEDIA KEYBOARD, MEDIA MONITOR, MEDIA MATE, MEDIA SCREEN AND MEDIABOOK

(71) Applicant: PHILIP J. SCHAAF, San Francisco, CA (US)

(72) Inventor: PHILIP J. SCHAAF, San Francisco, CA (US)

(21) Appl. No.: 14/283,042

(22) Filed: May 20, 2014

Related U.S. Application Data
(63) Continuation of application No. 12/976,553, filed on Dec. 22, 2010.
Application No. 12/976,553 is a continuation-in-part of application No. PCT/US2009/048337, filed on Jun. 23, 2009.
(60) Provisional application No. 61/121,695, filed on Dec. 11, 2008.
(60) Provisional application No. 61/116,113, filed on Nov. 19, 2008.
(60) Provisional application No. 61/103,636, filed on Oct. 8, 2008.
(60) Provisional application No. 61/074,881, filed on Jun. 23, 2008.

(51) Int. Cl. G06F 1/16

(52) U.S. Cl. CPC G06F 1/1601
USPC 361/679.05

(57) ABSTRACT

A computer system such as a laptop or Personal Digital Assistant and a computer peripheral such as a mouse, keyboard, monitor and other new devices wherein the user can create, acquire, assemble, file and transmit media to a display enabled screen or screens on the systems, peripherals or new devices, enhancing personalization through added functionality.

### CROSS-REFERENCE TO RELATED APPLICATIONS

This application is a continuation-in-part of PCT Application No. PCT/US2009/048337, filed on Jun. 23, 2009 and entitled INTEGRATING MEDIA DISPLAY INTO COMPUTER PERIPHERALS AND COMPUTING SYSTEMS: THE MEDIA MOUSE, MEDIA KEYBOARD, MEDIA MONITOR, MEDIA MATE, MEDIA SCREEN AND MEDIABOOK, which is a non-provisional of and claimed priority to U.S. Provisional Application No. 61/074,881, filed on Jun. 23, 2008 entitled MEDIA MOUSE, MEDIA KEYBOARD & MEDIA MONITOR; No. 61/103,636, filed on Oct. 8, 2008 entitled MEDIA MOUSE, MEDIA KEYBOARD, MEDIA MONITOR & MEDIA SCREEN; No. 61/116,113, filed on Nov. 19, 2008 entitled INTEGRATING MEDIA DISPLAY INTO COMPUTER PERIPHERALS AND SYSTEMS: THE MEDIA MOUSE, MEDIA KEYBOARD, MEDIA MONITOR, MEDIA MATE, MEDIA SCREEN AND MEDIABOOK; and No. 61/121,695, filed on Dec. 11, 2008 entitled INTEGRATING MEDIA DISPLAY INTO COMPUTER PERIPHERALS AND COMPUTING SYSTEMS: THE MEDIA MOUSE, MEDIA KEYBOARD, MEDIA MONITOR, MEDIA MATE, MEDIA SCREEN AND MEDIABOOK; each of which is incorporated herein by reference in its entirety.

### BACKGROUND

### Description of the Related Art

As intended, computer peripherals such as the mouse, keyboard and monitor assist a user in accessing, operating, programming, commanding, processing and communicating with the computer and/or its central processing unit (CPU) usually being connected via a cable such as a universal serial bus (USB) or communicating via a wireless connection such as Bluetooth. The computer mouse, for example, can point, select and transfer input, or commands, from the user to the computer via visual navigation related to the device's movements such as pointing and selecting on the monitor screen. In most traditional computer mice, the devices are protected by a hard plastic shell that surrounds it, with a rolling ball placed on the undercarriage to assist in accurate scrolling on the monitor/screen page and with its execution of user driven tasks. In most cases, the hard plastic shell is simply a colored protective cover and the design's emphasis is to create a durable product that comfortably fits the user's hand. Since its widespread adoption in the 1980's, the computer mouse has enjoyed many technical advancements that have impacted its performance in communicating, pointing, scrolling and selecting, but not much else.

Most computer peripherals have standard qualities. For example, most computer keyboards are rectangular and computer monitors are square. With respect to computer mice, most existing models have one main external humpback section that contours to the palm of the hand and is also the largest visible section of the device. In most cases, the functional parts of the devices are framed, protected or otherwise covered by a material such as hard plastics, polymers, rubber, synthetics, sometimes a form of metal or a combination of like materials.

### SUMMARY

Generally, embodiments described herein relate to devices, for example, computer peripheral devices such as computer mice, keyboards and monitors with integrated media displays, as well as to systems and methods related to the same. Traditionally, the emphasis of the design of peripherals such as mice was to create a durable product that comfortably fits the user's hand, not to be personalized to fit the user's visual design preferences. Computer keyboards and monitors, in widespread use for an even longer period of time than the mouse, have a similar background, meaning that they perform their intended tasks as they relate to computing, but do not offer much in the way of personalization for the computer user or enhanced distribution options for Internet or website content providers. For video game players, home electronic system and household appliance users, the same lack of personalization and content distribution opportunities through enhanced media display capabilities characterize the devices.

Knowing that consumers clearly enjoy the placement of personal, famous and licensed media on hundreds, if not thousands, of products, computer peripherals, laptop computers, personal digital assistants (PDAs), video game consoles, joysticks, cellular telephones (iPhone), other media devices (e.g., iPod, MP3 players, etc.), and home electronic equipment are logical extensions of this personalization phenomenon. Furthermore, content providers want to offer consumers more options to consume and benefit from real time information, transaction updates, product offers, correspondence and entertainment options like sports, music and dramatic art. Thus, several advantages of one or more aspects of the devices are to provide computer users with the ability to decorate, personalize or inform devices associated with the computing or gaming experience by installing media display screens on said devices and providing the means to transmit, project and broadcast media upon or through them. A further non-limiting advantage is that manufacturers of these types of products and intellectual property licensors can benefit from the described functionality by creating more useful and novel products for their customers.

The devices, systems and methods described herein can allow users of devices, for example, computer users and video game users, to personalize some computer and video game peripherals, laptop computers and PDAs with media, for example, media that includes but is not limited to: images, designs, digital content, colors, patterns, computer files, text, slideshows, video, moving images, software applications, audio, images that integrate sound, artwork, broadcasts, streaming content from an Internet source, static content from an Internet or file source, content from a specific partner or designated application source, content from a video game console source, content from a personal computer source and other related data from both internal and external sources or points of origin. Some embodiments relate to a laptop computer and a PDA with at least one extra display. Other embodiments relate to a device or devices, such as a computer mouse, computer keyboard and computer monitor with at least one display. Further embodiments relate to computer printers, fax machines, video game consoles and video game joysticks with at least one display. In some other embodiments of the technology, television sets, stereos, home electronic devices and household appliances can have at least one display screen or at least one extra display screen.

The devices can be configured and designed, for example, to transmit, project and broadcast media on an embedded, attached, integrated or otherwise connected display screen or screens on one or more of said devices. The “display screen or screens” located on or in the devices can be referred to herein as a “Media Screen” or “Media Screens.” The media displaying enabled peripherals can be referred to a “Media Mouse,” “Media Keyboard” and “Media Monitor.” Additionally, a new type of computer peripheral that features the display technology can be referred to as a “Media Mate,” and a media display enabled computer laptop can be referred to a “MediaBook.” The described devices can take any shape, be made of any suitable material; be accessed or directed via any suitable mechanism, including for example, software or an Internet source; be powered by a connective wire or cable such as USB, batteries, electric power source or a combination of similar inputs; and can communicate via wire(s) or wirelessly via technology such as Bluetooth®. While the labels Media Screen, Media Mouse, Media Keyboard, Media Monitor, Media Mate, MediaBook, etc. are used above to refer to various devices, it should be understood and appreciated that the terms are meant to broadly cover any device or devices described herein. The terms should not be used to limit the apparatuses to those described in this paragraph or elsewhere herein.

In some embodiments, for example, the devices can be designed and constructed to provide reasonably comfortable, durable working computer systems and computer peripherals that also allow for the placement of a Media Screen or screens onto the device(s). The screen or screens can fit into place or be secured to the devices by any suitable technique or method. For example, the screen or screens can be fitted into place, screwed, slotted, laid, inserted, glued by an adhesive, molded into a form, curved to fit a specific form, or otherwise adapted to adhere to the shape of the device or to fit in the desired location on the device. In some embodiments, various of the devices, methods and systems contemplated and described herein permit computer systems, computer peripherals, laptop computers, mobile computing devices, video game equipment, home electronic systems and the like to benefit in novel and useful ways from added personalization and broadcast capabilities in the form of media display of user generated or user selected media or provider specific media.

One embodiment relates to a peripheral device configured to interact with a computer. The peripheral device may comprise at least one display, a housing configured to support the display, a memory configured to store a display content, and a processor coupled to the display and to the memory. The processor may be further configured to output the display content to the display. The processor may also be configured to receive display content from the computer. The peripheral device may further comprise an input mechanism coupled to the processor. The input device may be configured to receive an input from a user. For example, a the peripheral device may display an e-mail reception notification, an instant message, a tweet, or various other forms of information. The input mechanism may allow a user to interact with the media on the peripheral device by, for example, scrolling through a received display content. Alternatively, the input mechanism could be configured to allow the user to cycle through a plurality of display content items. In various embodiments, the input device may be a button, a touch-screen, a knob, a slide, a biometric scanner, fingerprint detector, or other type on input. The input mechanism may be configured to communicate the user input to the processor. The processor may be configured to transmit the user input to the computer for action by the computer.

In another embodiment, the processor may be configured to transmit an identifier identifying the display content to the computer. The processor may be configured to determine a requested action based, at least in part, on the user input and to transmit an indication of the requested action to the computer. In various embodiments, the requested action may comprise displaying the display content on a primary display coupled to the computer or transmitting a different display content to the peripheral device. The processor may be configured to output the different display content to the display.

The memory in the peripheral device may be configured to store a content source identifier. The processor may be configured to transmit the content source identifier to the computer. In one example, the content source identifier may comprise a uniform resource locator.

The peripheral device may further comprise a connector configured to mate with a corresponding connector on a primary display of the computer. In various embodiments, the connector may be a threaded fastener, a clip, a joint, or an interlocking sleeve.

The housing supporting the display may have a form factor associated with a theme. The display content may be associated with the theme.

The display content may be selected based, at least in part, on a user selection. Further, the display content may comprise an advertisement. Alternatively, as mentioned above, the display content may comprise an e-mail, a tweet, an instant message, a text message, a picture message, a video message, a social networking message such as a face book type message, or other types of content. Alternatively, the display content may comprise a notification indicating reception of any a message such as the messages described above.

In various embodiments, the peripheral device may be a computer mouse, a computer keyboard, an auxiliary monitor, or a handheld computing device. For example, the peripheral device may be an auxiliary monitor that connects to or interfaces with a connector located on the perimeter of a traditional computer display. Alternatively, the peripheral device may be a handheld device such as a smart phone or a digital media player such as an iPod.

The memory in the peripheral device may be configured to store computer readable instructions for interacting with the peripheral device. The processor may be configured to transmit the computer readable instructions to the computer. The memory may also be configured to store a uniform resource locator (URL). The URL may be associated with computer readable instructions for interacting with the peripheral device. The processor may be configured to transmit the URL to the computer.

Another embodiment relates to an apparatus for facilitating the display of media. The apparatus may comprise a primary display, a memory, an input mechanism, and a processor coupled to the memory and to the display. The processor may be configured to receive a connection indication from a peripheral device, to obtain display content, and to transmit the display content to the peripheral device. In addition, the memory may be configured to store one or more display content options. The processor may be configured to select the display content from the one or more display content options. In one example, the processor may be configured to select the display content based, at least in part, on a user input received via the input mechanism.

The memory may also be configured to store a user display content preference. The processor may be configured to receive a user identification, determine an association between the user display content preference and the user identification, and select the display content based, at least in part, on the user display content preference. The user identification is received via the input mechanism. Alternatively, the user identification is received via the peripheral device.

The processor may also be configured to receive from the peripheral device a content source identifier and to access a content source associated with the content source identifier. In one example, the content source identifier may be a uniform resource locator.

As described above the display content may comprises an advertisement, an e-mail, a tweet, an instant message, a text message, a picture message, a video message, a social networking message such as a face book type message, or other types of content. Alternatively, the display content may comprise a notification indicating reception of any a message such as the messages described above.

The processor may also be configured to receive from the peripheral device an indication of a user interaction with the display content. In various embodiments, the processor may be configured to output the display content to the primary display or to determine a different content selection and to output the different display content to the peripheral device in response to the user interaction indication.

The processor may be configured to obtain display content by receiving an incoming content from a content source. As described above the display content may comprises an advertisement, an e-mail, a tweet, an instant message, a text message, a picture message, a video message, a social networking message such as a face book type message, or other types of content. Alternatively, the display content may comprise a notification indicating reception of any a message such as the messages described above.

Another embodiment relates to a method, operating on a peripheral device, of displaying content. The method may comprise transmitting a connection indication from the peripheral to a computer, receiving, at the peripheral, a display content from the computer, and displaying, at the peripheral, the display content. The method may further comprise receiving, at the peripheral, a user input via an input mechanism and transmitting the user input to the computer. The display content may be selected based, at least in part, on the user input.

The method may further comprise transmitting an identifier identifying the display content to the computer. The method may also comprise determining a requested action based, at least in part, on the user input and transmitting an indication of the requested action to the computer. In various embodiments, the requested action may comprise displaying the display content on a primary display coupled to the computer, transmitting a different display content to the peripheral device from the computer and displaying the different content, or other actions.

The method may further comprise transmitting a content source identifier to the computer. In one example, the content source identifier comprises a uniform resource locator. The method may also comprise physically connecting the peripheral device to a primary display of the computer. In another example, may further comprise providing a housing for the peripheral device. The form factor of the device may be associated with a theme. The display content may also be associated with the theme. As described above the display content may comprises an advertisement, an e-mail, a tweet, an instant message, a text message, a picture message, a video message, a social networking message such as a face book type message, or other types of content. Alternatively, the display content may comprise a notification indicating reception of any a message such as the messages described above.

The method may also comprise transmitting computer readable instructions for interacting with the peripheral device to the computer. Alternatively, the method may comprise transmitting a uniform resource locator (URL) to the computer. The URL may be associated with computer readable instructions for interacting with the peripheral device.

Another embodiment relates to a method, operating on a computer, of displaying content on a peripheral device. The method may comprise receiving, at the computer, a connection indication from a peripheral device, obtaining a display content, and transmitting the display content from the computer to the peripheral device. Obtaining the display content may further comprise determining one or more display content options and selecting the display content from the one or more display content options. The method may further comprise receiving, at the computer, a user input and obtaining the display content the display content by selecting the display content based, at least in part, on the user input.

The method may further comprise determining a user display content preference, receiving, at the computer, a user identification, and determining an association between the user display content preference and the user identification. Obtaining the display content may comprise selecting the display content based, at least in part, on the user display content preference. The user identification may be received from the peripheral device.

The method may further comprise, receiving from the peripheral device, a content source identifier. In this example, obtaining the display content may comprise accessing a content source associated with the content source identifier. The content source identifier is a uniform resource locator.

As described above the display content may comprises an advertisement, an e-mail, a tweet, an instant message, a text message, a picture message, a video message, a social networking message such as a face book type message, or other types of content. Alternatively, the display content may comprise a notification indicating reception of any a message such as the messages described above.

The method may also comprise receiving, at the computer, an indication of a user interaction with the display content from the peripheral device. In various embodiments, the method may comprise displaying the display content on a primary display associated with the computer or obtaining a different content selection and transmitting the different display content from the computer to the peripheral device in response to the user interaction indication.

Obtaining the display content further comprises receiving an incoming content from a content source. As described above the incoming content may comprises an advertisement, an e-mail, a tweet, an instant message, a text message, a picture message, a video message, a social networking message such as a face book type message, or other types of content. Alternatively, the incoming content may comprise a notification indicating reception of any a message such as the messages described above.

Another embodiment relates to a display device. The display device may comprise a display, a positioning member coupled to the display, and a connector, coupled to the positioning member, and configured to connect to a corresponding connector disposed on the housing of a computer display. In various embodiments, the positioning member may be configured to extend telescopically, rotate, be deformable, or have one or more joints. The display may be configured to rotate relative to the positioning member.

The connector may comprise an anchor configured to support the weight of the display and the positioning member. In one example, the connector may be a USB connector. The connector may be configured to attach to the perimeter of a display region of a laptop, netbook, mini, PDA, handheld or to the perimeter of a desktop monitor. The connector may comprise a connection to a power source. The connector may also comprise a base and at least one support member that connects to a power source. Further, the connector may comprise at least one support member of any length. The display may comprise a peripheral device described above.

Another embodiment relates to a method of displaying media. The method may comprise providing a peripheral device described herein, connecting the peripheral device to the perimeter of a desktop, netbook, mini, PDA, handheld, or laptop monitor, and displaying media on the peripheral device. In one embodiment, the desktop, netbook, mini, PDA, handheld, or laptop may comprise an apparatus described herein.

The foregoing is a summary and thus contains, by necessity, simplifications, generalization, and omissions of detail; consequently, those skilled in the art will appreciate that the summary is illustrative only and is not intended to be in any way limiting. Other aspects, features, and advantages of the devices and/or processes and/or other subject matter described herein will become apparent in the teachings set forth herein. The summary is provided to introduce a selection of concepts in a simplified form that are further described below in the Detailed Description. This summary is not intended to identify key features or essential features of the claimed subject matter, nor is it intended to be used as an aid in determining the scope of the claimed subject matter.

### BRIEF DESCRIPTION OF THE DRAWINGS

The foregoing and other features of the present disclosure will become more fully apparent from the following description and appended claims, taken in conjunction with the accompanying drawings. Understanding that these drawings depict only several embodiments in accordance with the disclosure and are not to be considered limiting of its scope, the disclosure will be described with additional specificity and detail through use of the accompanying drawings.

FIG. 1 illustrates an example of how media can be sent from a personal computer or CPU to a display area such as a Media Screen or screens, mounted on a device.

FIG. 2A depicts an example of a top view of a computer mouse.

FIG. 2B depicts an example of a top and angled side view of a computer mouse.

FIG. 3A depicts an example of a top view of a Media Mouse with a single fixed position Media Screen.

FIG. 3B depicts an example of a top view of a Media Mouse wherein a region of the device is capable of display.

FIG. 3C depicts an example of a top view of several versions of a Media Mouse.

FIG. 3D depicts and example of a top view of two different images of the same Media Mouse.

FIG. 3E depicts an example of a top and angled side view of two different images of a Media Mouse.

FIG. 3F depicts an example of a top and angled side view of two different images of a Media Mouse.

FIG. 3G depicts an example of a top view of a Media Mouse.

FIG. 4A depicts an example of a top view of four different versions of a Media Mouse that has been specially configured to resemble a dog's paw.

FIG. 5A depicts an example of a top view of two different images of a Media Mouse that exemplifies what a specially designed device, through a hypothetical licensing agreement with the rock band The Rolling Stones, can look like.

FIG. 6A depicts three examples of images depicting a top view of a computer peripheral often referred to in this application as a Media Keyboard.

FIG. 7A shows three examples of images depicting a frontal view of a computer peripheral often referred to herein as a Media Monitor.

FIG. 8A shows four examples of images depicting a frontal view of a device that is often referred to in this application as a Media Mate.

FIG. 9A shows three examples of images depicting a Media Mate.

FIG. 10A shows two examples of different views, a side and a frontal, of another embodiment of a Media Mate.

FIG. 11A shows an example of a top view of two different versions of a Media Mate as a mouse pad.

FIG. 12A shows four examples of different images of a device that is often referred to in this application as a MediaBook.

FIG. 13A shows an example of a frontal view of a MediaBook in the “open” position.

FIG. 14A depicts two examples of images, both frontal views, of a Media Monitor.

FIG. 15A shows three examples of top view images of a MediaBook, two of the device in the “half open” position and one in the “closed” position.

FIG. 16A shows four examples of different images of a MediaBook in the “half open” position.

FIG. 17A shows four examples of devices with different sized and shapes to the corresponding Media Screens of said devices.

FIG. 18A shows three examples of devices that can connect directly to another device, which can be its power source.

FIG. 19 is a diagram showing examples of a possible architecture to support multiple displays and devices that include multiple functions.

FIG. 20 is a diagram showing an example of one possible design for a media device account management system.

FIG. 21 shows four examples of devices that can connect directly to another device, which can also be its power source, for the purpose of display.

### DETAILED DESCRIPTION OF THE PREFERRED EMBODIMENT

In the following detailed description, reference is made to the accompanying drawings, which form a part hereof. In the drawings, similar symbols typically identify similar components, unless context dictates otherwise. The illustrative embodiments described in the detailed description, drawings, and claims are not meant to be limiting. Other embodiments may be utilized, and other changes may be made, without departing from the spirit or scope of the subject matter presented here. It will be readily understood that the aspects of the present disclosure, as generally described herein, and illustrated in the Figures, can be arranged, substituted, combined, and designed in a wide variety of different configurations, all of which are explicitly contemplated and make part of this disclosure.

Generally, embodiments described herein relate to at least one extra display device that can be included with or built into laptop computers, at least one display device built into computer systems, at least one display device built into computer peripherals, display devices as peripherals themselves, and methods for transmitting media to said devices as well as functionality for the computers that include such devices and the for the devices. In some embodiments, the devices, systems, and methods specifically can exclude as an “extra” display the primary display of the device, for example the computer monitor or monitors.

Some embodiments relate to a device where the overall design allows said device to retrieve, store, transmit, project, display and play various media including, for example, but not limited to: images, designs, colors, digital content, patterns, computer files, text, slideshows, video, moving images, software applications, audio, images that integrate sound, artwork, broadcasts, streaming content from an Internet source, static content from an Internet or file source, content from a specific partner or designated application source, content from a video game console source, content from a personal computer source, content from a cellular phone, content from other computing devices, and other related and like data.

The devices can permit a user to insert, decorate, or personalize their peripheral(s) or media enabled area(s) such as a Media Screen or screens with media of their own choosing, including for example, media that can be delivered from an Internet source or stored in common computer files such as a GIF, JPEG, BMP, WMV, MOV, AVI, MPEG, TIFF, or documents from MS Word, MS Excel and other applications.

The Media Screen or screens and/or display enabled areas can be in any desired shape, including for example, square, rectangular, circular, triangular, spherical, cubic, pyramid shaped, diamond shaped, star shaped, mounded, tetrahedral, oval, elliptical, trapezoidal, shaped as a parallelogram, five sided, six sided, seven sided, eight sided, nine sided or ten sided or constructed in unique shapes that fit with the design of the larger device. The screen or screens can be designed and configured to permit the use of any suitable display technology, including for example, liquid crystal display (LCD), light-emitting diodes (LED), organic light-emitting diodes (OLED) technology or other projection/display transmission technology, including technology fashioned from materials that include one or more of glass, plastic, plasma, organic molecules, organic compounds, polymers and/or other projection/display capable materials or components that can facilitate display in an active or a passive matrix or other form of visual display. These and other embodiments will become readily apparent to those skilled in the art from the following detailed description of the embodiments having reference to the attached figures, the invention not being limited to any particular embodiment(s) disclosed.

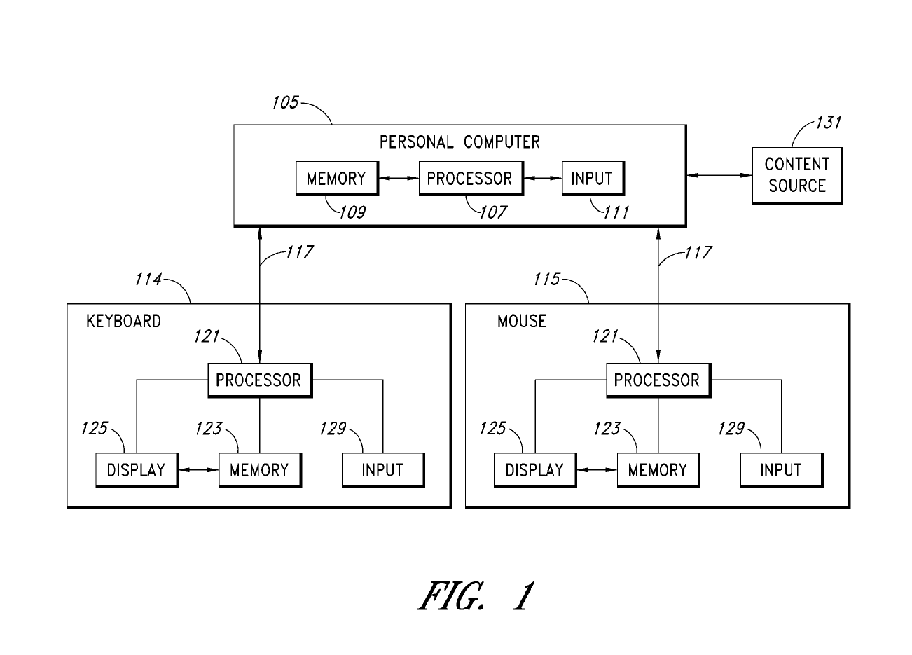

In FIG. 1, the term “display enclosure” refers to a peripheral device such as the Media Mouse, Media Keyboard, Media Monitor and/or Media Mate. FIG. 1 illustrates a personal computer (PC) 105. It will be appreciated that a personal computer is used for explanatory purposes, but that other computing devices such as mobile telephones, smart phones, or other types of computing devices may be employed. The PC 105 includes a processor 107. The processor 107 may be configured, as described below to facilitate the use of peripheral devices in displaying content to users. The processor 107 is coupled to a memory 109. The memory 109 may be configured to store computer executable instructions for enabling the various methods and processes described herein. Further, the memory 109 may be configured to store various forms of media for display on one or more devices, including for example, one or more peripheral devices as described herein. In another embodiment, as described below, the memory may be used to store user preferences for content and/or broadcast selection and may facilitate the association of particular content and/or broadcasts with particular users or particular peripheral devices. The processor 107 further may be coupled to an input device 111. As described below, the input device 111 may facilitate user input and various content selection schemes. It will be appreciate that the functionality of the user input 111 may be also be implemented in one or more the peripheral devices described below. The processor 107 may also be coupled to a primary display (not shown). As described herein, the primary display may be used in conjunction with the one or more peripheral devices or other devices. The PC 105 may also communicate with one or more content sources 131. As described below, the content source 131 may comprise a server on the Internet, physical media accessible by the computer, or other sources of information.

FIG. 1 also illustrates a pair of exemplary peripheral devices, the mouse 115 and the keyboard 119. Each of the peripherals 115, 119 may function according to its traditional capabilities in addition to the beneficial features described herein. Each of the peripheral devices, 115, 119 may include, for example, a processor 121. The processor may be configured to facilitate both the traditional functionality associated with the peripherals as well as the additional functionality described herein. Similar functionality may be implemented by software running on the processor 107 of the PC 105. This may include, for example, multiplexing of signals or other signaling schemes for communicating with the PC 105. As described below, the processor 121 may be configured to receive and transmit content and other information from and to the PC 105 via a link 117. It will be appreciate that the link 117 may be configured as any of a variety of communication links such as USB, RS232, PS2 or a wireless link. The peripheral devices 115, 119 further comprise a memory 123. As described below, the memory 123 may be configured to store content to be displayed, content source identifiers, computer executable instructions for interacting with the peripheral, and other types of information to facilitate the processes described herein. The processor 121 may be further coupled to a display 125. As described below, the display may be shaped or configured to fit a particular peripheral device or the display and the peripheral device may be shaped according to a particular theme. The processor 121 may be further coupled to an input device such as the input device 127 of the keyboard 119 or the input device 129 of the mouse 115. The input devices, 127, 129 may be configured to receive user interaction with the peripheral devices, 119, 115. As described below, the received user interaction may be used to affect the content being displayed on the display 125. Alternatively, the inputs 127, 129 may be used to trigger actions by the personal computer 105 described below. For example, a user input via the input 127 may be transmitted to the processor 121. The processor 121 may transmit the user input along with an indication of the current content being displayed to the PC 105 via the link 117. In response, the PC 105 may display the current content on a primary display or may determine an alternative display content to transmit to the peripheral device 119.

For the purpose of explanation, it may be useful to consider the operation of the systems illustrated in FIG. 1. For example, a user may connect the PC 105 and the keyboard 119 via a link 117, such as a USB wire. The PC 105 and the keyboard 119 may exchange one or more connection initiation messages to establish a connection. The PC 105 may then proceed to determine an appropriate display content for the keyboard 119. In one example, the PC 105 may receive an indication from the keyboard 119 requesting content from a particular content source 131. In another example, the PC 105 may receive an input from the keyboard 119 or via the input device 111 that a particular user is using the keyboard 119. In response, the PC may determine a different content source 131 or particular content, by accessing the memory 109. The PC may also select content for the keyboard 119 in other ways described below. In one specific example, the PC 105 may determine that the keyboard will display e-mail reception notifications. Thus, each time the PC 105 receives an e-mail from a content source 131, it can output an indication of the e-mail receipt to the keyboard 119 via the link 117. This indication may be pre-processed by the PC for display at the keyboard 119, or may be left unprocessed for further processing at the keyboard 119. After receiving the indication, the keyboard 119 outputs the indication to the display 125. A user, may then interact with the indication via the input mechanism 127. For example, the user may press a button indicating that she would like to view the e-mail on the primary display associated with the PC 105. Alternatively, the user can view the e-mail on the display for the peripheral device. If the user desires to view the e-mail on the display associated with the PC 105, then the keyboard 119 may transmit the user request, and possibly an identifier identifying the particular message, back to the PC 105 via the link 117. The PC 105 may then display the e-mail on the primary display.

It will be appreciated that the memory elements 109, 123 may include, for example, processor cache, including a multi-level hierarchical cache in which different levels have different capacities and access speeds. The memory elements 109, 123 may also include, for example, random access memory (RAM), other volatile storage devices, or non-volatile storage devices. The storage may include hard drives, optical discs, such as compact discs (CDs) or digital video discs (DVDs), flash memory, floppy discs, magnetic tape, and Zip drives. The memory elements 109, 123 may also include, for example, video buffers.

One or more of the functional blocks and/or one or more combinations of the functional blocks described with respect to the PC 105 and the peripheral devices 115, 119, such as the processors 107, 121 may be embodied as a general purpose processor, a digital signal processor (DSP), an application specific integrated circuit (ASIC), a field programmable gate array (FPGA) or other programmable logic device, discrete gate or transistor logic, discrete hardware components, or any suitable combination thereof designed to perform the functions described herein. One or more of the functional blocks and/or one or more combinations of the functional blocks described may also be implemented as a combination of computing devices, e.g., a combination of a DSP and a microprocessor, a plurality of microprocessors, one or more microprocessors in conjunction with a DSP communication, or any other such configuration.

It will be further appreciated that while the peripheral devices 119 and 115 were described as a keyboard and mouse, other devices, including peripherals such as a MediaBook, PDA, handhelds, video game console, video game peripheral such as a joystick, home electronic devices such as a television or stereo, and other devices may implement similar functionality.

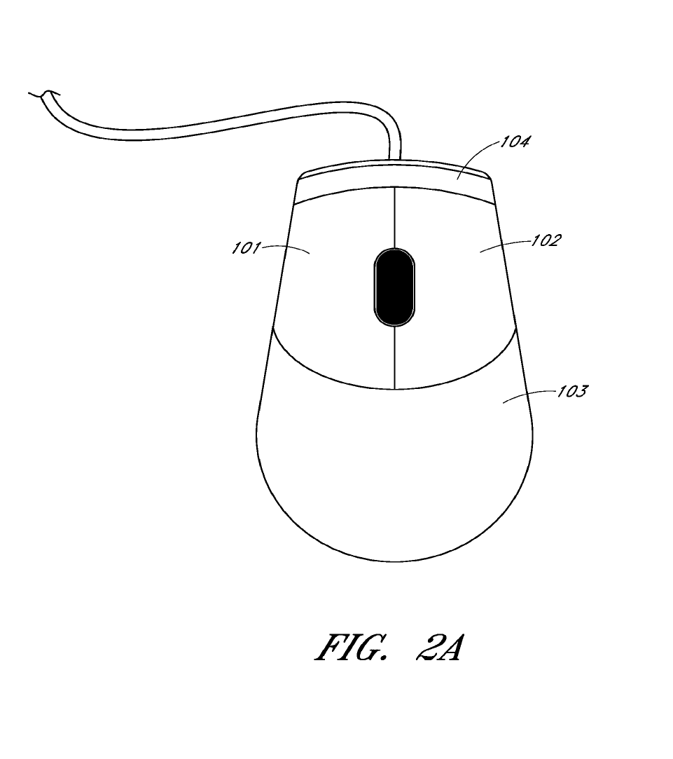

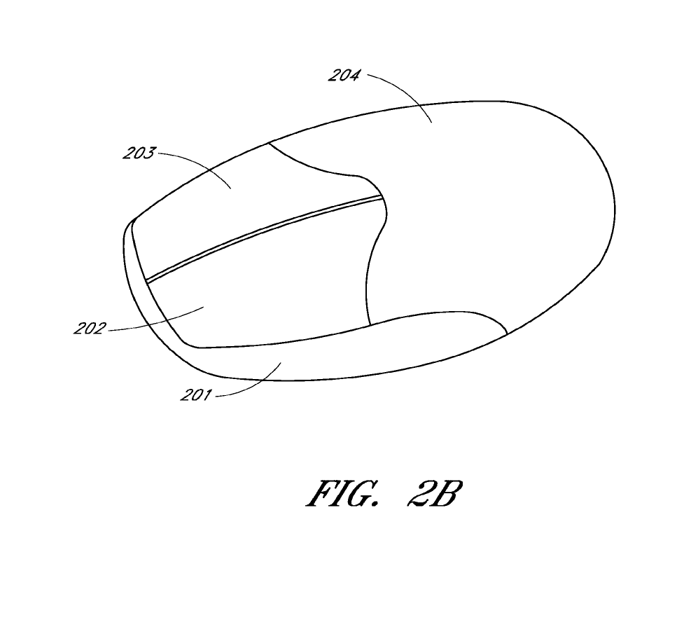

FIG. 2A shows a top view of a computer mouse according to an embodiment, where three regions or quadrants 101, 102 and 103 are clearly visible. A fourth quadrant 104 is marked and denotes the front area of the device, the piece that curves away from the top towards the base that runs flush to the surface such as a tabletop.

FIG. 2B provides a top and angled side view of a computer mouse, where sections 201, 202, 203 and 204 can be identified separately.

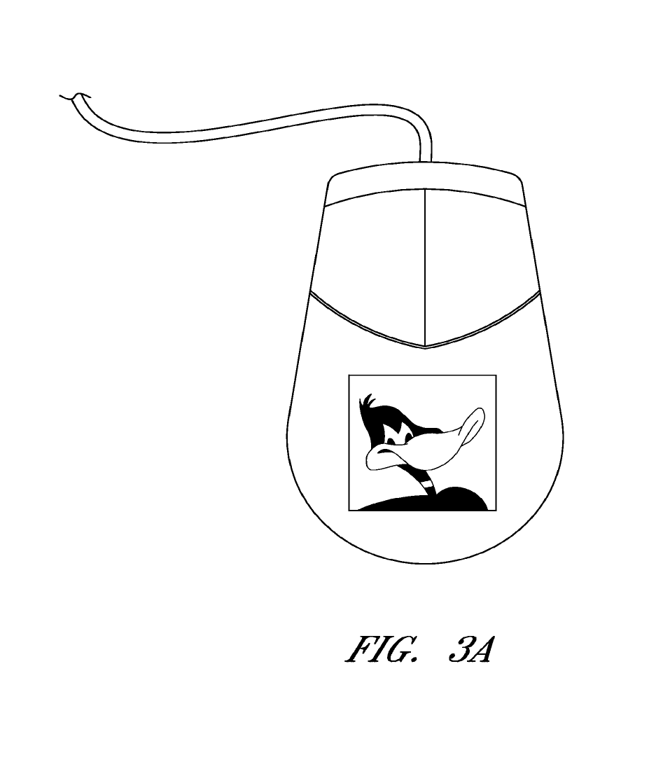

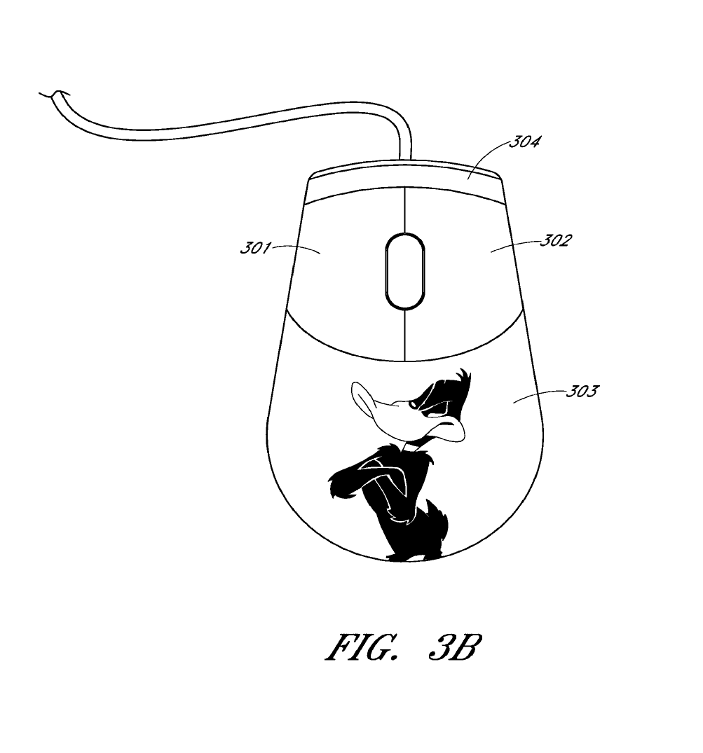

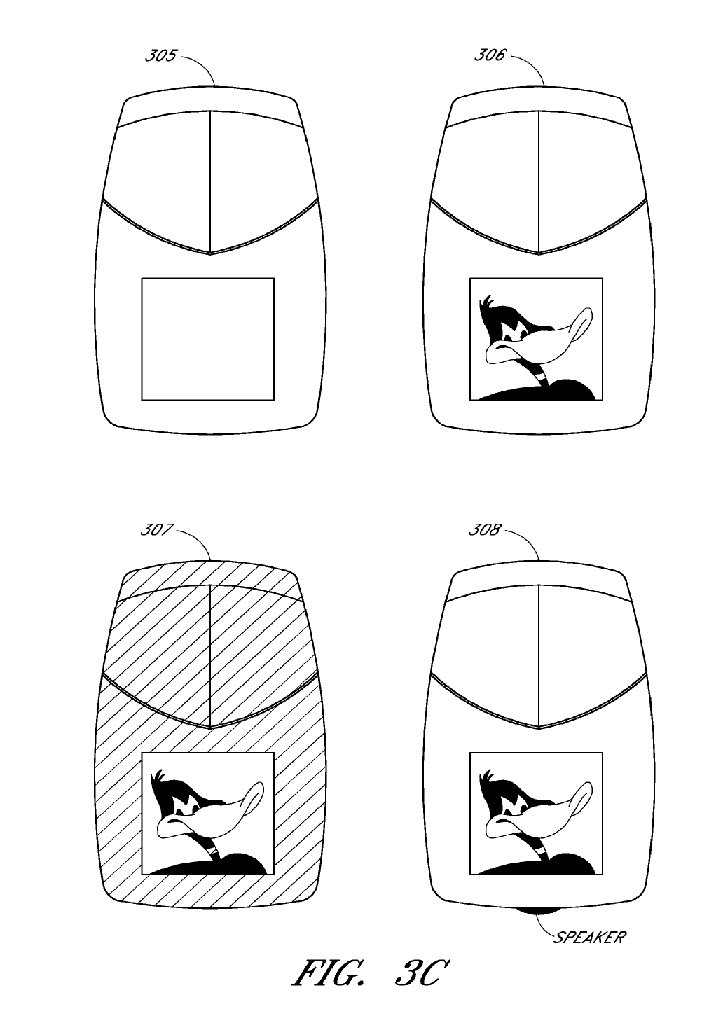

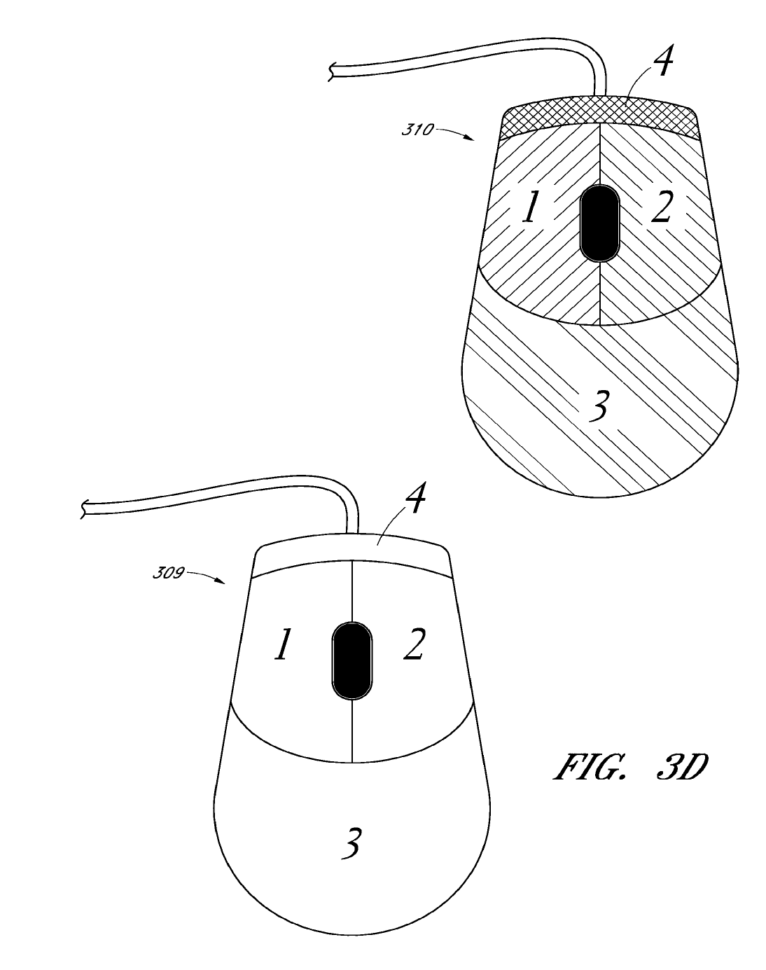

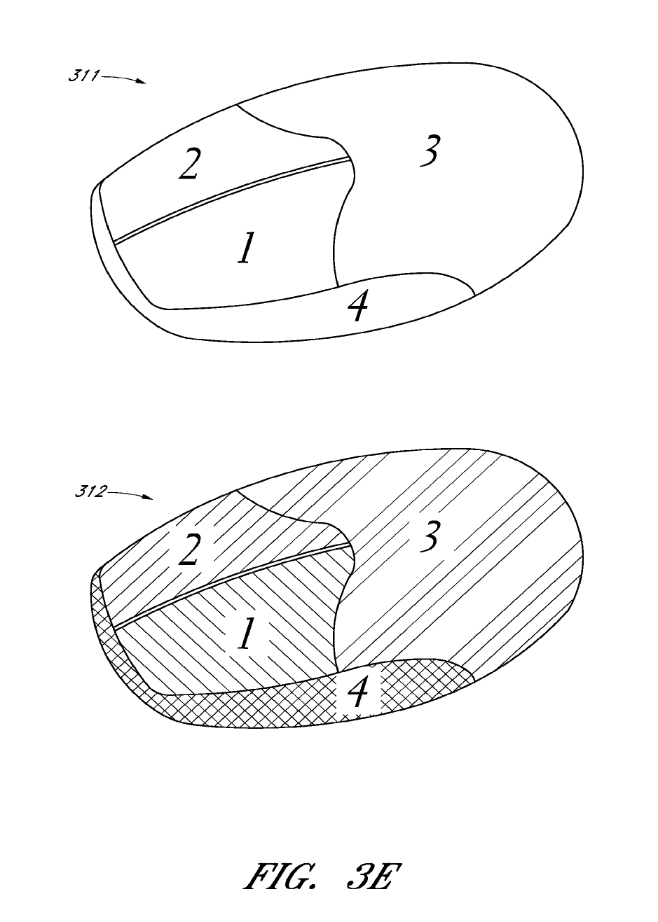

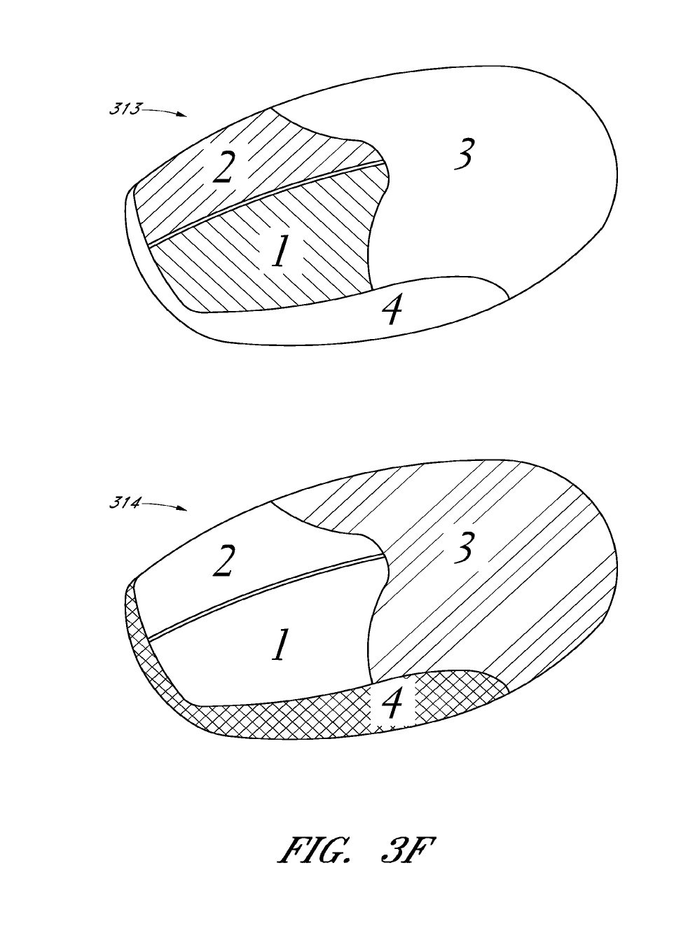

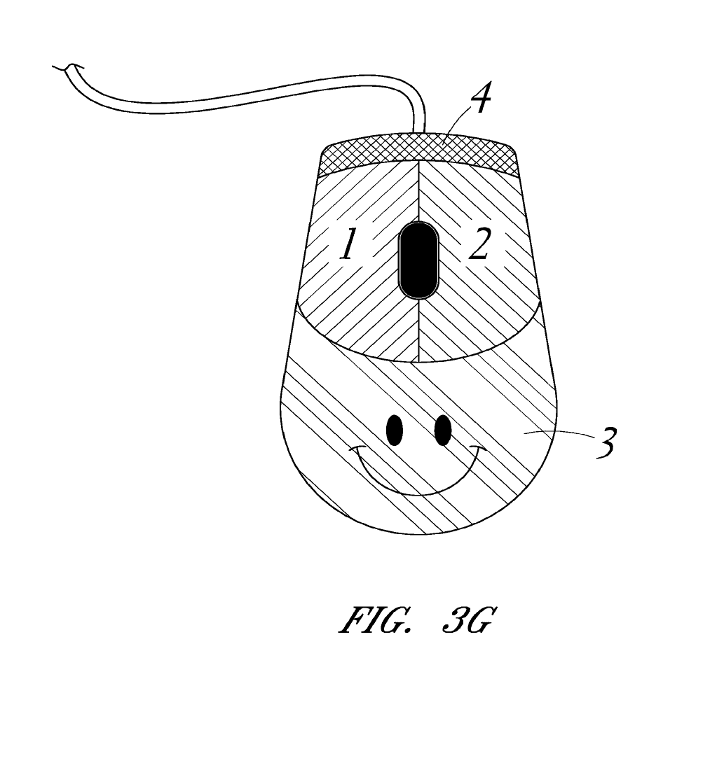

FIG. 3A is a top view of a Media Mouse according to a further embodiment, shown after it has downloaded a popular image, Daffy Duck, to a display screen, AKA Media Screen, which has been embedded in a fixed position in the main body of its shell.

FIG. 3B is a top view of a computer Media Mouse according to a further embodiment shown after it has downloaded a popular image, Daffy Duck, to a region 303 on the device wherein the entire region is capable of display, i.e. in this embodiment, download and display is not restricted to an embedded, framed Media Screen. The construction of the device is made of a surface that can display media where the other defined regions 301 and 302 can be capable of display as well. Region 304 refers to the very front of the device, the piece that curves away from the top towards the base that runs flush to the surface such as a tabletop. In some embodiments, display can occur in region 304 as well.

FIG. 3C is a top view of several versions of a Media Mouse that demonstrate different capabilities and configurations of an embodiment with a fixed position Media Screen embedded into its shell. The first device 305 is at rest prior to having received any images for download. The second device 306 has only received the image of Daffy Duck. Device 307 has received the image of Daffy Duck and is also constructed of a colored plastic, as represented by the shaded areas, in all of its external visible regions. Device 308 has a speaker located at the bottom of the device, meaning that it can play music and or video accompanied by audio and/or broadcast media featuring video and/or audio. While the depicted device is described as having a speaker at the bottom, it should be appreciated that one or more speakers can be included at any other location on the devices. A Media Mouse can also be a peripheral device where a display located on said device can identify a user to a computer system by biometric scan. For example, in image 305 the Media Screen can be an interface such as a biometric scanner that reads a user's thumbprint where that can be equivalent to a “login” identifier to the computer system. In some embodiments, the biometric or identity scanning device can be plugged into other universal computing units and configure the unit to the user's preferences, files and personal information. In other embodiments, the Media Screen could feature a touch-screen command that allows users to send a command directly from the Media Screen to the main monitor in its own prioritized browser. For example, this could be an e-mail, text message or some other response driven form of content.

FIG. 3D is a top view of two computer mice that demonstrate the capabilities of the Media Mouse that was displayed in FIG. 3B. Device 309 is a “before” where the device has not been designed or assigned images to its display capable regions numbered 1, 2, 3 and 4. The device depicted in picture 310 is “after” the device has been designed and/or assigned downloads, for example, different colors as represented by shading to regions 1, 2, 3 and 4. The humpback region, or quadrant 3, can be assigned, for example, the color orange. The left click area or quadrant 1 can be assigned the color blue. The right click area, or quadrant 2, can have the color green downloaded to it and the front section, or quadrant 4, can be purple. Of course, not all of the quadrants have to be assigned a color. They can display other media.

FIG. 3E is the embodiment from FIG. 2B but in a “before and after” scenario whereby the image 311 is the “before” any media has been assigned or downloaded to it and image 312 is the “after” where media, as indicated by the shaded areas, was assigned via relevant communication to the four display capable regions numbered 1, 2, 3 and 4 of the device.

FIG. 3F is the same embodiment from FIG. 2B, but with different display capable regions displaying content as indicated by the shading. In image 313, quadrants 1 and 2 have shading, which indicates that the user decided to download media to these two areas on the Media Mouse. In image 314, two different regions have been assigned media for display. The device, as depicted in both 313 and 314, shows that media can be displayed on four different quadrants, but that the user can choose to not display on all available display areas.

FIG. 3G is an embodiment of the Media Mouse where the device has received a download of a “smiley face,” where the shaded areas represent the background color yellow that accompanies the image, to all four display quadrants, 1, 2, 3 and 4, or its entire visible external space, an option the device user can choose in its account management software. The downloaded image can be assigned, for example, to appear as a separate image in each region, restricted to appear in a specific region or it can also be assigned as one image appearing across any combination of the display capable regions.

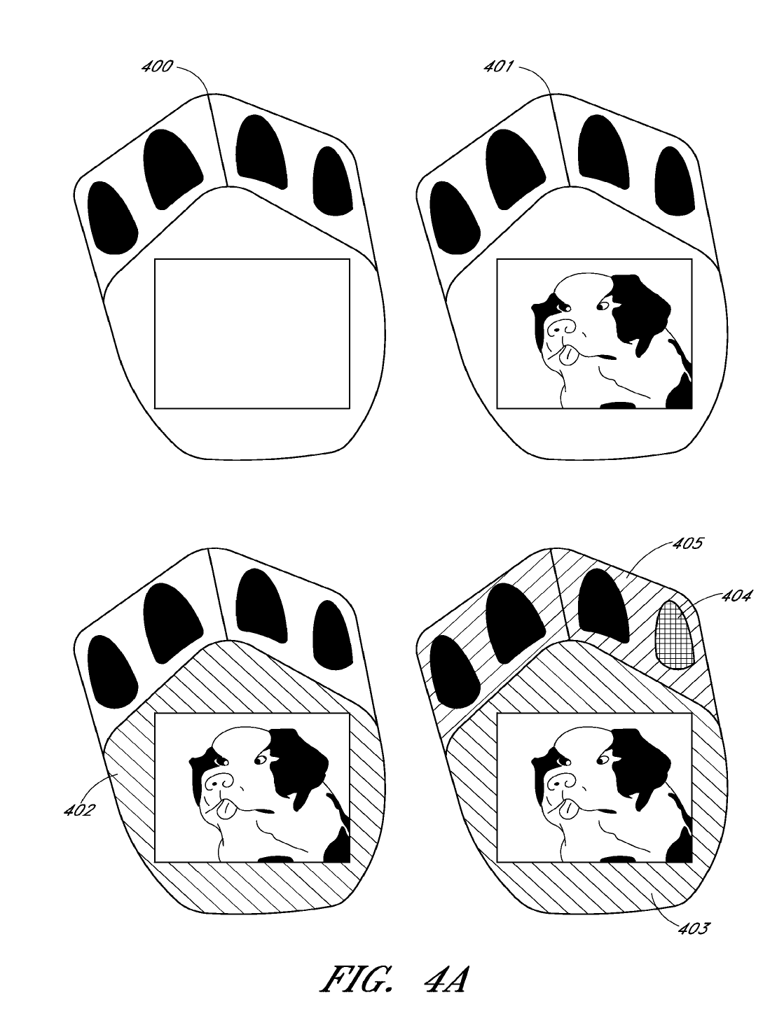

FIG. 4A is a top view of four different versions of a Media Mouse that has been specially configured to resemble a dog paw with a display capable screen, or Media Screen, embedded in its main body. Image 400 is the device “before” an image has been downloaded to its Media Screen. Image 401 is the device “after” the device owner has downloaded a picture of her St. Bernard dog, ‘Mimosa,’ onto the device's Media Screen. Image 402 is the device with an embedded Media Screen and surrounded by colored plastic as represented by the shaded area in order to enhance the visual appeal. Image 403 shows two other features of the device: more coloring added to the external surface in area 405 and a speaker 404 that is camouflaged as a paw pad. In some embodiments of this device, ‘Mimosa’ the St. Bernard can be programmed to bark when a user identified event such as an appointment or calendared milestone such as a meeting occurs or when an e-mail arrives in the operator's Inbox. The bark can come out of a speaker or sound system found on the Media Mouse itself or via integration of the Media Mouse device into the sound system of the main computing apparatus/CPU. The Media Screen in the devices depicted in FIG. 4A can also display non-canine media. Additionally, further embodiments of the Media Mouse can have different external shells that reflect other recognizable shapes that can thematically personalize a device. This and all other embodiments can also broadcast media from content providers as well. For example, this type of device could be given away at Petco Park, home of the San Diego Padres as part of a promotion where the device could also broadcast Padres baseball games (and related content) in addition to transmitting media from Petco and their vendors such as lams. Other sounds can be used as desired, including sounds that relate to the displayed media or with the shape of the device. For example, if the device were in the shape of an automobile, then the sound might be the sound of an engine, a horn, etc. Similarly, if desired, different sounds can be assigned for different events or types of media.

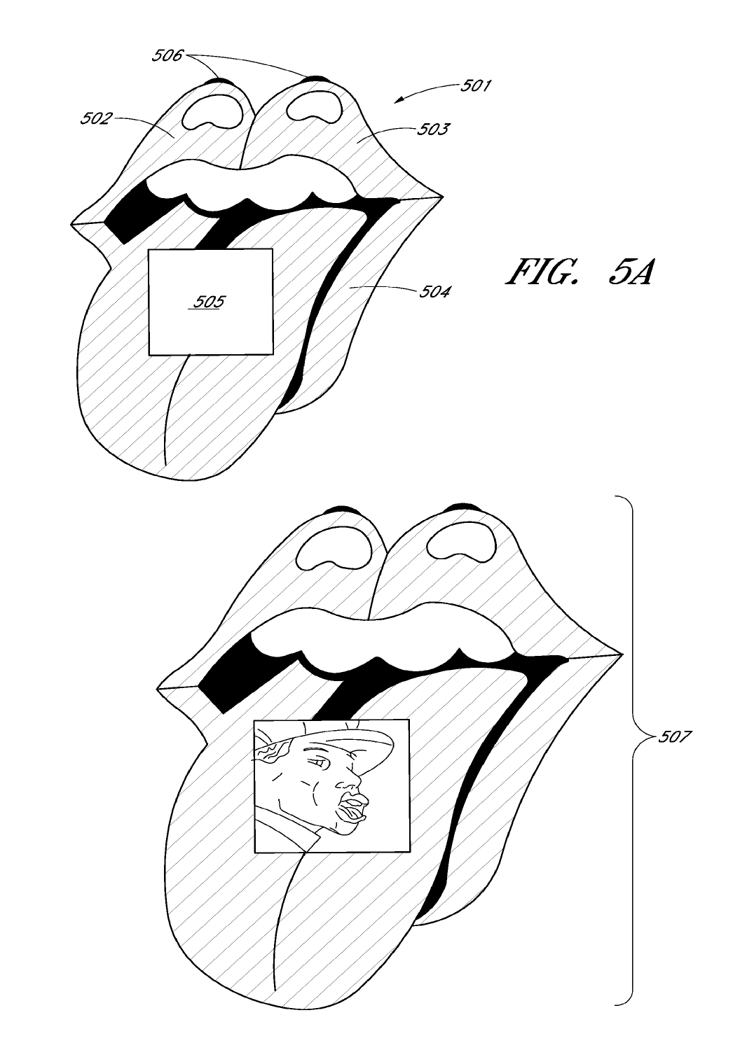

FIG. 5A is a top view of a Media Mouse that exemplifies what a specially configured mouse, through a hypothetical licensing agreement with the rock band The Rolling Stones, would look like. Image 501 is a “before” picture, not drawn to scale, where the light and dark shaded regions represent the colors red and black respectively, 502 is the left click quadrant, 503 is the right click quadrant, 504 is the main body of the device that contains the embedded display or Media Screen 505 that receives media downloads that can are enabled for sound with speakers 506. Image 507 is the “after” version that has been blown up where an image of lead singer Mick Jagger has been downloaded and appears on the device's media enabled screen 505. In one embodiment, the non Media Screen aspect of the Rolling Stones branded device can be in traditional red, white and black plastic of the logo surrounding the Media Screen. In yet another embodiment, the whole device can be capable of projecting images and the red, white and black portions are simply projections or transmissions of colors for display. In this type of promotional arrangement, the designated device(s) can benefit from special considerations with respect to accessible content, in addition to promotional and media inventory. Similar to the dog paw and other embodiments described above, sounds can be used to designate the occurrence of an event, for example, music or other audio related to the event and/or nature of the peripheral (e.g., Rolling Stones music).

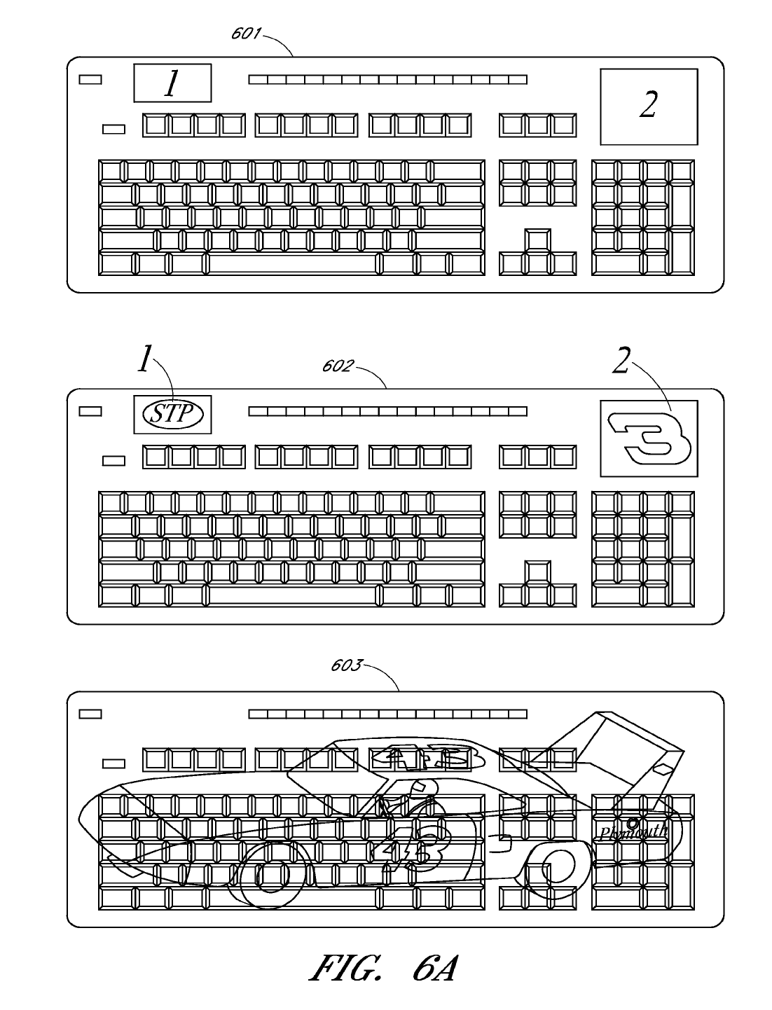

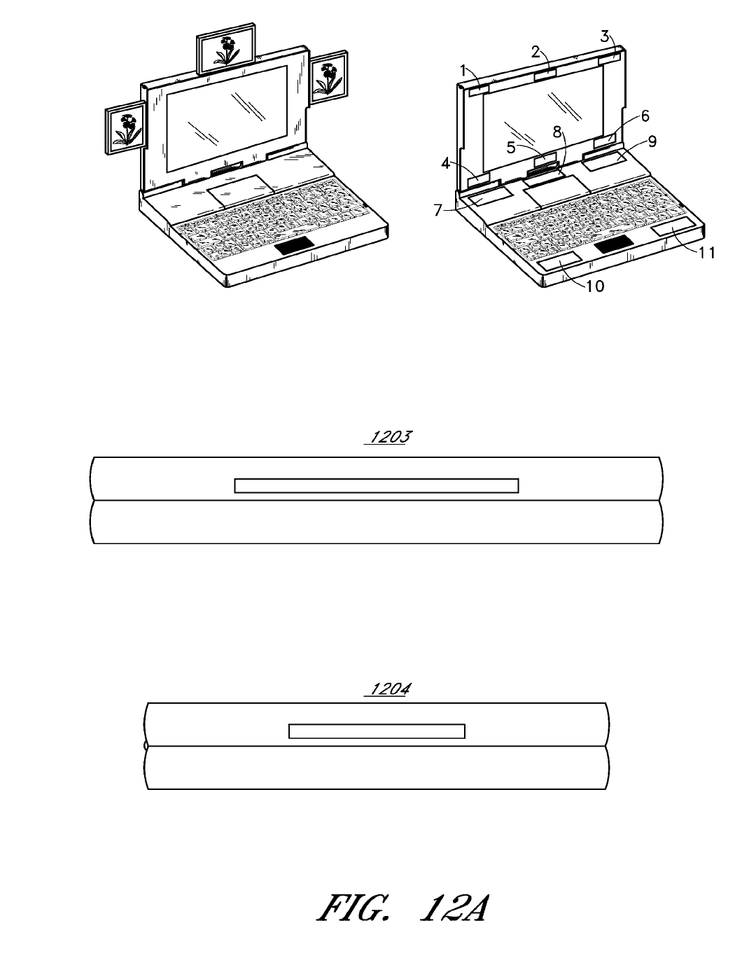

The display technology can also be applied to the keyboard environment in a product referred to as the Media Keyboard, where areas such as the frame of the computer keyboard can be configured to receive and display media content on a Media Screen or screens. FIG. 6A features embodiments of a Media Keyboard. The first image 601 shows a Media Keyboard before it has been assigned a media download in either of its two Media Screen areas, numbered 1 and 2. Image 602 shows a Media Keyboard adorned with a couple of downloaded images in the depicted Media Screen areas: the famous STP logo to Media Screen, 1, and the familiar number three that adorned Dale Earnhardt's famous racecar to Media Screen, 2. Image 603 demonstrates the background download option whereby a user operator can send an image to the device as a background download, in this case, Hall of Frame driver Richard Petty's renowned #43 Plymouth. This capability means that the Media Keyboard can transform its main body with a background display feature that downloads media to the device without blurring the actual key designations. In other words, this background display feature spreads the image over a large part of the keyboard device, including the actual keys, without obscuring their designated denominations so that the desired media appears, but it does not overwhelm the device, obstruct the keys, hinder or diminish keyboard operation in any way. As in other embodiments, the Media Keyboard can have a Media Screen or screens that can slide out from any of the four sides of the main apparatus like a cartridge release Media Screen depicted in other devices, such as the MediaBook in FIG. 12A. This means that the Media Screen, or screens, can be hidden from view, but once deployed, the user's desired media can then be activated for enjoyment or utility purposes. In yet another embodiment, a screen can be attached to an outlet built into the frame of a Media Keyboard, i.e. plugged into the device for powering and fixed position display, even with the capability to angle, or adjust it, towards the user. In short, the Media Keyboard enhances personalization opportunities as well as content provider distribution opportunities in association with a desktop computer or attachment to a docking station device or laptop computer. In yet another embodiment, a Media Keyboard can have a Media Screen with the biometric scanning capabilities in order to identify a computer user and allow the user access to a computer system and further embodiments could have the touch-screen capabilities that allow a user to select that communication for immediate priority on the main monitor of the computer system by simply touching it.

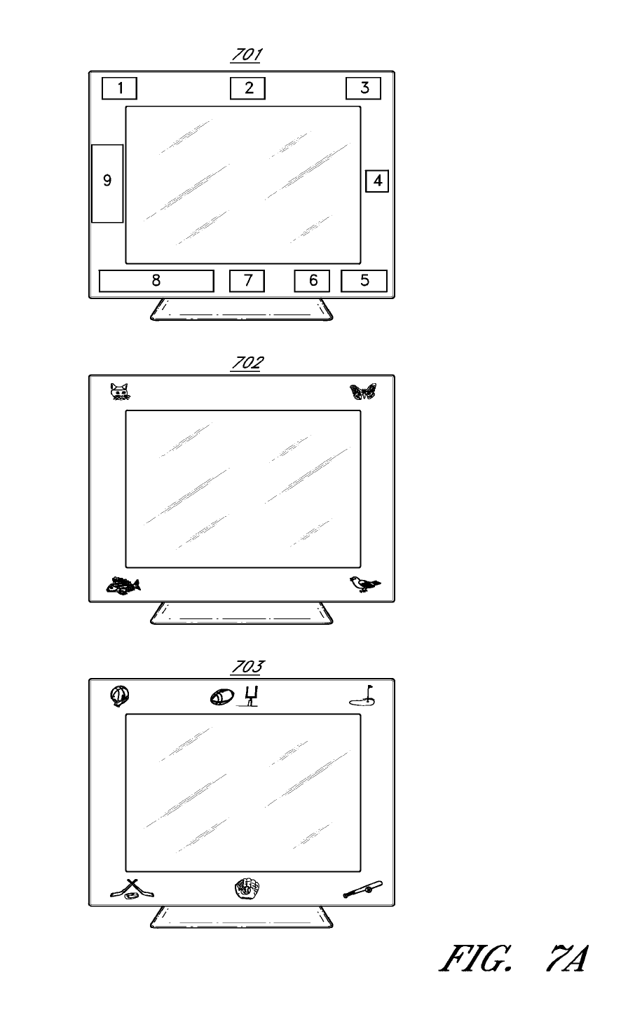

FIG. 7A shows three images of an embodiment of a computer peripheral frequently referred to in this application as a Media Monitor. Image 701 shows a Media Monitor before any items have been downloaded to its nine Media Screens, numbered 1, 2, 3, 4, 5, 6, 7, 8 and 9. The bottom two images, 702 and 703, show the device after some images have been downloaded to various Media Screens. Image 702 shows a nature or animal theme and image 703 reflects a sports theme. As shown, users can display images on some enabled Media Screens on the Media Monitor but not on others. This offers a user the choice to segment or compartmentalize the functionality to their choosing. The Media Monitor can, in some embodiments, take moving images and place them in stationary places or send information or images around the perimeter of the monitor in moving, real time sequence. For example, a news ticker, or stock ticker, can travel around a Media Monitor's frame if the monitor screen was framed by sufficient media display materials or components, in essence a Media Screen encircling the majority or entirety of the monitor screen. This frame enabled capability to encircle a Media Monitor can also be integrated into other devices. In yet another embodiment, a Media Monitor can have a Media Screen with the biometric scanning capabilities in order to identify a computer user and allow the user access to a computer system or to access a particular application via touch-screen capability.

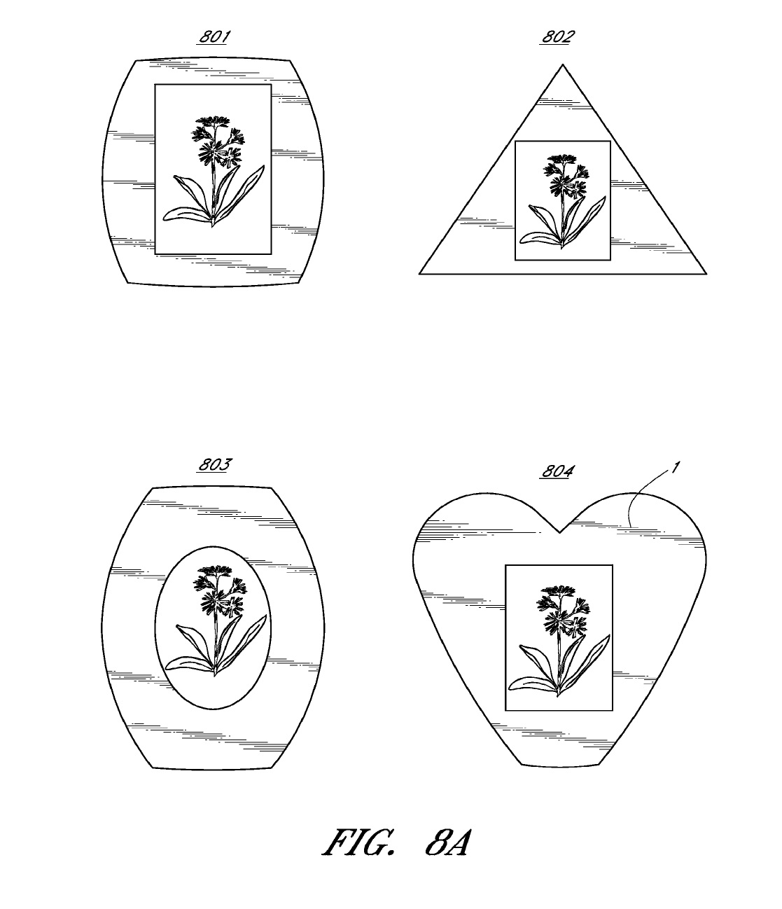

FIG. 8A shows frontal views of various embodiments that a Media Mate can take. Image 801 shows a four-sided Media Screen framed by curved sides and a flat top and flat bottom. Image 802 shows a triangular frame with embedded rectangular screen. Image 803 shows a device with an oval frame and oval display screen. Image 804 is specially designed as a heart shaped frame where the shading, 1, represents red plastic or a display that can light up in red, with a rectangular Media Screen embedded in the device. The Media Mate devices, as depicted here, feature sufficiently flat thick bases and flat backs that can be in the range of approximately one half of an inch to twelve inches to support it in the positions shown here, i.e. perpendicular to a flat surface, or lying on a flat surface, such as a desk or tabletop. The proposed Media Mate device, or devices, can complement, augment, integrate with, or act entirely separate from the Media Mouse, Media Keyboard, Media Monitor and MediaBook. It can take many shapes, such as a freestanding picture screen or frame or even a traditional paperweight, meaning that it can stand perpendicular on, or lie parallel to, a traditional tabletop surface. Some Media Mate devices can also have a hidden command, or keyboard command system that can be concealed and deployed for use, such as a clamshell design. As indicated by the heart design in image 804, Media Mates can feature thematic designs of animate or inanimate objects to enhance the personalization choices for consumers and customer offerings for manufacturers and content providers. Additionally, there can be Media Mate embodiments having a Media Screen with biometric scanning capabilities that identify a computer user and allow the user access to a computer system and, in some embodiments, touch-screen capability.

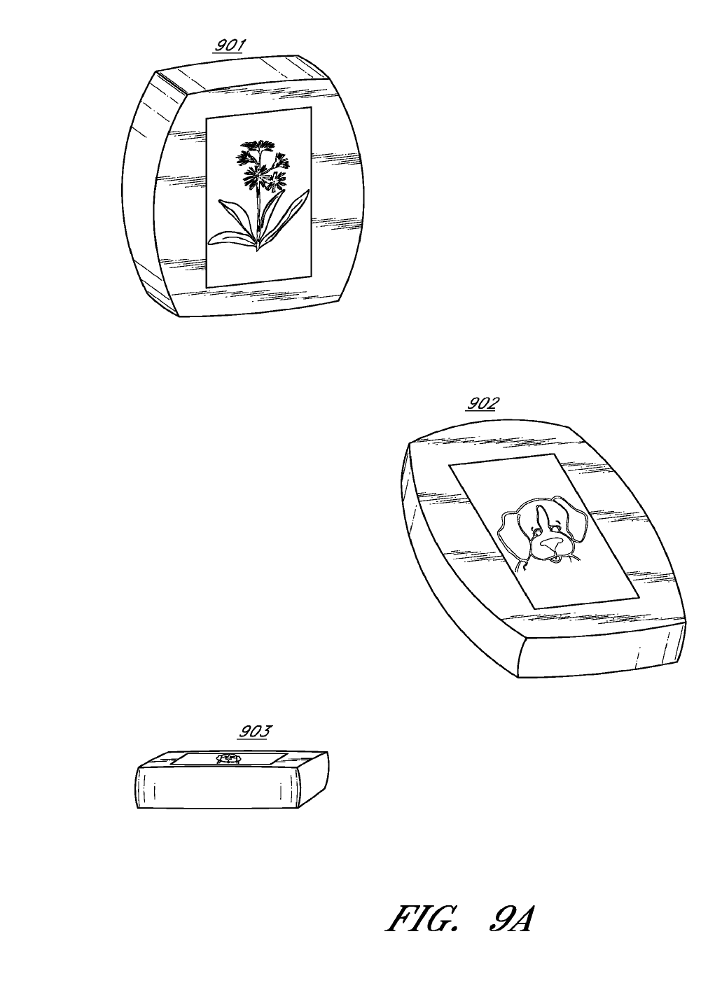

FIG. 9A shows three images of a Media Mate. In image 901, the device is standing on its base, perpendicular to a surface such as a tabletop, and has a flower picture on its Media Screen. In image 902, the same Media Mate device is lying down, flush on a surface such as a tabletop, with a St. Bernard picture on the screen. The pictures 901 and 902 show that the same device can be deployed in either position as various embodiments can have the dual capacity to be perpendicular to the surface, or lying upon it, as the backside, as in this instance, can be flat and flush to the tabletop surface. Image 903 shows the side view of the same device lying down, flush on a surface such as a tabletop, where the outline of the screen is visible, but there is no image depicted on it. Some embodiments can also have frame stands on the back side of the device, either embedded in them so as to not inhibit their ability to lie flat on their back sides, or attached so the position standing upright, or perpendicular, to a horizontal tabletop surface, is the preferred deployment. Also, embodiments of a Media Mate can have a display wherein the display can identify a user to a computer system by biometric scan. The identification can then act as a “login” for the user to a computer.

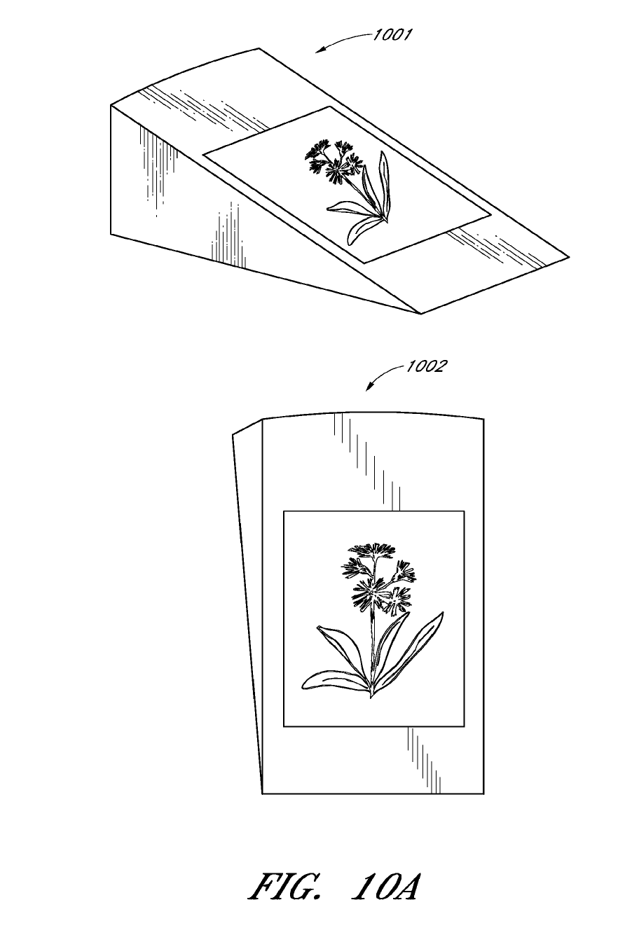

FIG. 10A shows two views of a different embodiment of a Media Mate. Image 1001 depicts a side view of the Media Mate that has a flat base where the Media Screen is angled from back to front towards the user when the device lies with its base flush to a surface, almost like a wedge. Image 1002 shows a frontal view of the same wedge-like Media Mate. In some embodiments, the angle can be adjusted, i.e. tilted, by the user via a control. Furthermore, in some embodiments, the Media Screen can be removed for cleaning and/or replacement if necessary. The base can be of solid, or of hollow, construction and have control buttons, concealed or exposed, located upon it.

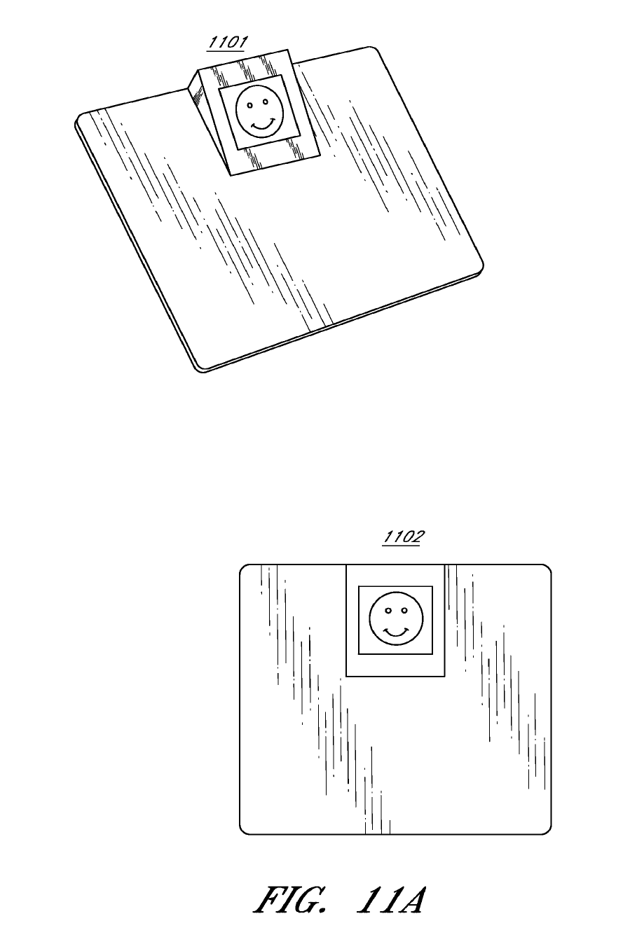

FIG. 11A shows how a Media Screen can be embedded in a mouse pad, or, in other words, how a Media Mate can be a mouse pad. In this application, the Media Screen is built into the mouse pad itself, embedded at one end of a pad, which can be made of rubber, synthetics, cloth, plastic, silicon in their relevant combinations to assist in the tasks associated with mouse operation, such as providing a sufficient horizontal surface for a pointing device such as a Media Mouse to slide over and scroll against. Image 1101 shows a screen with a picture of a ‘smiley face’ on it set at the top of the mouse pad where the screen is angled from back to front, or towards the user. Image 1102 shows the same picture of a ‘smiley face’ except the screen is not angled; it lies flat and flush to the surface of the mouse pad. In some embodiments, an entire mouse pad can be capable of receiving and displaying media and the mouse can slide over and scroll against the surface. Like other devices described herein, the embodiments depicted in FIG. 11A can be battery powered, communicate wirelessly, or powered via a connective cable such as USB and display media essentially consisting of but not limited to: images, designs, colors, digital media, patterns, computer files, text, slideshows, video, audio to a sound system engineered into the device, integrated sound with the host computer apparatus/CPU, artwork, broadcasts, streaming content from an Internet source, static content from an Internet or file source, content from a specific partner or designated application source, content from a video game console source, content from a Personal Computer source and other related data.

FIG. 12A represents two of the ways that the expanded media capabilities can be implemented in a MediaBook. For example, a MediaBook can have an embedded cartridge Media Screen as depicted in images 1201, 1203, 1204, and a fixed position Media Screen or screens on its interior as shown in image 1202 when the device in the “open” position. The embedded cartridge version means the display Media Screen or screens can be stored inside the housing of the device much like a CD ROM or DVD drive and deployed by the user pressing a release button, or similar mechanism. In other words, the MediaBook can be computer laptop having at least one transversal hole in a midsection thereof wherein at least one extra display can be stored and deployed to a position visibly advantageous to the user. In some aspects, the Media Screen cartridge can be located on the top or monitor half of the MediaBook. In some other instances, the cartridge can even be located on the bottom or keyboard half of the MediaBook from where the Media Screen deploys. In some embodiments, the Media Screen can adjust to angle advantageously towards the user via a hinge or similar mechanism after it has been deployed. In some other MediaBook embodiments, a user can also fold the Media Screen elements out from an ‘at rest’ inset position built into the MediaBook's encasement, or connect a Media Mate to a prefabricated slot to the unit or slide-on a Media Screen attachment to the computer itself. Additionally, other devices such as a Media Mouse or Media Mate can be connected to, and powered by, the MediaBook via a cable or wire such as Universal Serial Bus and communicate wirelessly via a standard such as Bluetooth®.

In FIG. 12A, image 1201 is an “open” MediaBook device that demonstrates the flip-out, or cartridge released, Media Screen or screens that can receive and display media. Image 1201 depicts three favorable areas, ones that correspond to the three flower drawings, from where the Media Screen cartridge can be released, or flipped out from a cavity within the device. As shown, the three Media Screens in image 1201 can be advantageously deployed for visual purposes from the top, right and left side of the half of the laptop that feature the monitor screen, commonly referred to as the “top half” of the open laptop. Image 1201 demonstrates how the display capabilities can be helpful in those instances where an individual is looking at reference material on a deployed Media Screen or screens that can facilitate, impact and/or influence work such as language translation, viewing an instructional tutorial or transcribing meeting notes to a file on the main monitor screen of the MediaBook. As shown, a MediaBook can have more than one Media Screen. In cases of MediaBooks with multiple Media Screens, the user can pursue multiple tasks simultaneously, e.g. file work, broadcasting content, conducting two-way conversation and displaying reference information.

In FIG. 12A, image 1202 is an “open” MediaBook device that shows eleven places, numbered 1, 2, 3, 4, 5, 6, 7, 8, 9, 10 and 11, where an embedded Media Screen can appear on the device. In some embodiments, a MediaBook can feature both a flip-out or cartridge released, Media Screen or screens deployed from the top half of the open device as depicted in image 1201 and an embedded Media Screen or screens elsewhere on the open device, such as in ones depicted in image 1202. Additionally, in some instances, Media Screens can be cartridge released from the bottom half of the MediaBook laptop computer and have embedded Media Screens on parts of the device. Additionally, versions of MediaBooks can be equipped with a Media Screen having biometric scanning capabilities in order to identify a computer user via a thumb or finger print and allow that user to “login” to the computer system or otherwise access the device. Furthermore, the aforementioned touch-screen capabilities can also apply to Media Screens found in various MediaBook embodiments.

In FIG. 12A, images 1203 and 1204 show a closed MediaBook laptop computer that has the cartridge based Media Screen technology wherein the cartridge released Media Screen or screens are contracted into the device. Image 1203 shows a frontal view of a closed MediaBook where the Media Screen is contracted into the top-half of the device, specifically on the top side of the top half when the cartridge Media Screen is released by a button, much like a CD Rom/DVD drive, in the “open” position. Image 1204 shows a MediaBook with a cartridge/insert Media Screen on one of the sides of the device in the contracted position. It, too, has a release button that allows the Media Screen to spring out to the side of the monitor half, or top half, of the laptop computer when being operated. The release button can be a spring-loaded mechanism, or some other tension driven lock and place system conventionally found in similar systems such as a CD ROM or DVD drive. One of the purposes of the cartridge/insert Media Screen, aside from providing elegant media display capabilities, is to protect the Media Screen when not deployed in a space-efficient manner Like the other devices, the MediaBook's Media Screen or screens can display media essentially consisting of but not limited to: images, designs, colors, patterns, computer files, text, slideshows, video, moving images, software applications, audio, images that integrate sound, artwork, broadcasts, streaming content from an Internet source, static content from an Internet or file source, content from a specific partner or designated application source, content from a video game console source, content from a Personal Computer source and other related data.

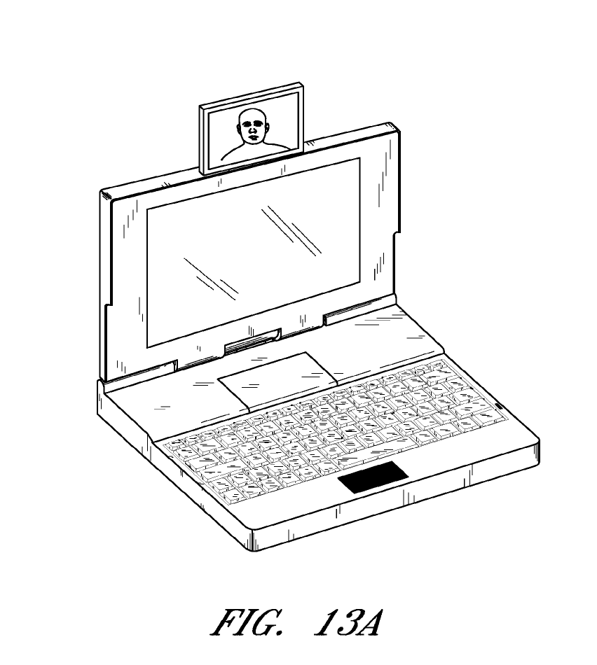

FIG. 13A shows an open laptop computer embodiment, a MediaBook, where there is a camera lens inserted into the top portion of the laptop so that it can transmit the image of the person using the laptop and possibly send it to a similarly enabled device elsewhere in order to enhance a conversation that two individuals can conduct via the Internet. The cartridge released, or flip-out, Media Screen that appears at the top of the picture shows the person that the computer operator is speaking to in this hypothetical example. Some devices, such as the Media Monitor, MediaBook and Media Mate, can also include an embedded camera element that can facilitate enhanced two-way conversation or correspondence. In these instances, the camera can capture the images in its field of data capture and send the information to a target destination, including where a Media Screen or screens can project those images via a special application or software program. Simultaneously, the individual can display on his/her Media Screen the images captured by the other person's camera or video capture element meaning that the two individuals can be engaged in conversational broadcast. These two-way capabilities can facilitate correspondence with an individual, group, or larger “chat” session with individuals who have devices and/or programs with similarly enabled media capabilities. The cartridge released, or flip-out, screen can also be deployed from the side of the device in certain embodiments. The camera can also be integrated elsewhere into the device, it does not have to be in the middle of the top half of an open laptop computer and it can also be part of another attachment such as a Media Mate. The camera can also be used as an identifier of a computer system operator, meaning that the camera element can scan a user's face in conjunction with, or separate from, a Media Screen that reads a thumb, or finger, print.

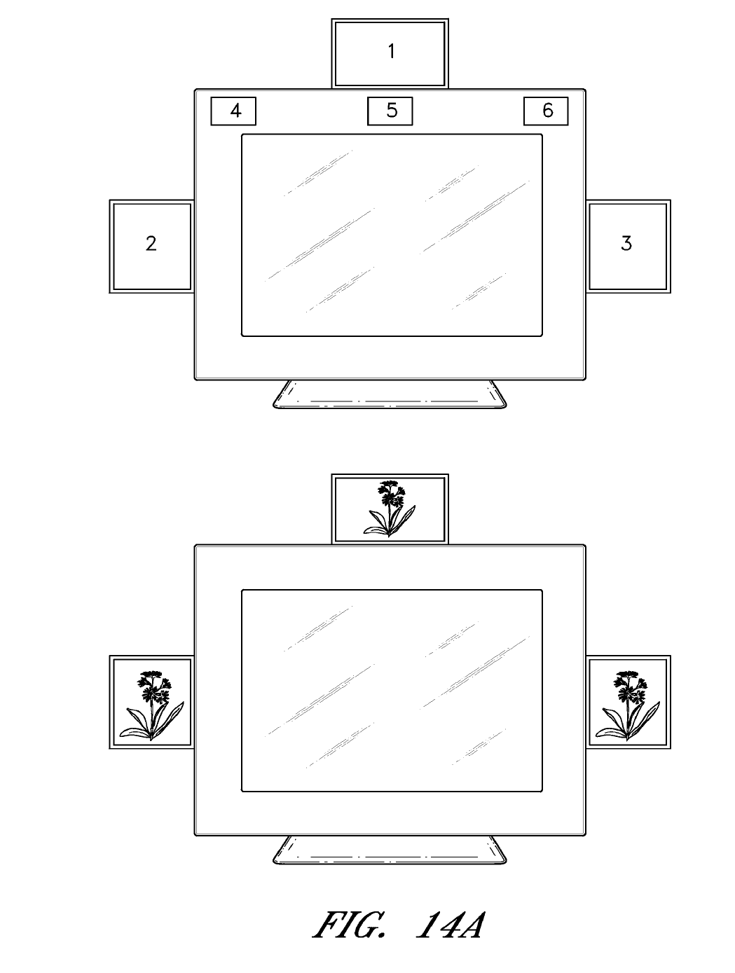

FIG. 14A shows two images of a Media Monitor. Image 1401 shows a standard desktop Media Monitor with three places Media Screens can be, such as the top and the two sides, positions that correspond to the numbers 1, 2 and 3 in image 1401. These Media Screens can be cartridge inserts, flip-out models, or attachments that are plugged into prefabricated slots. Certain embodiments can feature camera technology for transmitting images elsewhere, such as positions 4, 5 and/or 6 in image 1401. Image 1402 shows a larger depiction of a desktop Media Monitor that can have one, two or three Media Screens. Some Media Monitors can have embedded fixed position Media Screens in addition to cartridge released ones. Also, in some embodiments, a cartridge release Media Screen, flip-out Media Screen or embedded Media Screen can be affixed on, near or at the bottom portion, which is the side facing the user/operator closest to the base of the Media Monitor to display media.

There can be other embodiments of a Media Monitor. For example, a Media Screen can be attached to a prefabricated outlet, such as a USB, built into the frame of a Media Monitor, meaning that it plugs into the device for powering, connectivity and fixed position display. In some embodiments of this attachment type configuration, the Media Screen can be affixed at the end of an extension apparatus that either is straight, angled or bendable where some can communicate wirelessly and others are powered via the said apparatus. The extension apparatus can feature at least one post that connects into the host device and it can be of any length from one quarter of an inch to ten inches in total length or any value in between. In some embodiments, the extension apparatus can even be telescopic, where the user can vary the length and even angle of the connected Media Screen. In yet another embodiment, a special Media Mate can be externally attached to a regular computer monitor, or other place in and around someone's desk, workstation or place of computing by a clip, sleeve or interlocking attachment system that allows for a device to be affixed to something at an individual's discretion. These items can communicate wirelessly or via a cable or wire to the CPU or main computing apparatus. There can also be Media Monitor devices, for example in the flat screen category, where the Media Screen or screens are either the cartridge release type or ‘flip-out’ from a hinged position behind the main computer monitor for viewing.

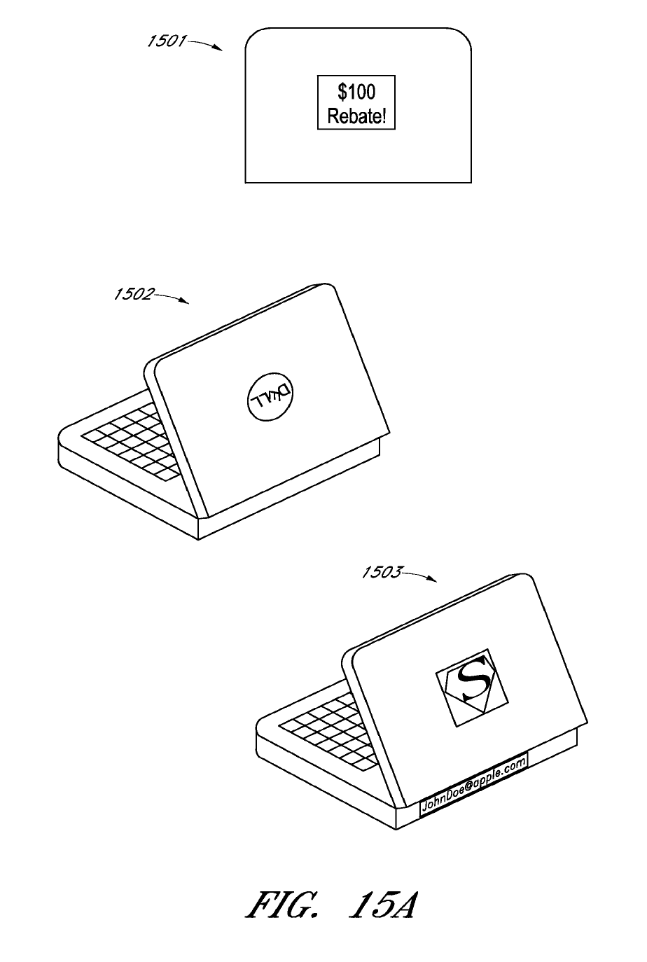

FIG. 15A shows three images of a computer laptop, a MediaBook, enabled with a Media Screen on the exterior of the device's encasement. Image 1501 shows a top view of a closed laptop that has a “$100 Rebate” on its Media Screen. This can be the manner in which a manufacturer sends a unit to a retailer, or the way a retailer displays the unit for sale, in order to attract attention to it on the shelf. Image 1502 shows a top view of a half open MediaBook laptop with the logo of a manufacturer, Dell, that hypothetically licensed the Media Screen technology to, among other things, place a Media Screen on the outside of a laptop to light up their corporate logo. Image 1503 shows a top view of a non-manufacturer branded MediaBook that is in the half open position. It has a Media Screen on the external, outside encasement and the user has downloaded a Superman logo to it. The three images, 1501, 1502 and 1503 all demonstrate that Media Screens can appear on the outside of a MediaBook for the purposes of media display and can be embedded anywhere on the outside of the device in one, two, three, four, five, six or more places. Externally mounted Media Screens can be inserted flush to the surface, or they can be inset, or sunk below the hard plastic or protective external surfaces of the MediaBook, in order to protect the screen from getting heavily scratched in usage, transportation and normal wear and tear. Alternatively, some embodiments can feature an externally mounted Media Screen that can be slightly raised to enhance its prominence. Furthermore, some embodiments can even have an adjustable Media Screen where it can be raised or lowered with respect to the surface of the frame from where it is placed. Lastly, the Media Screens in the image 1501 and 1503 show a different orientation, or rotation of the image, than the image 1502. Specifically, assuming that the word ‘rebate’ is closest to the hinge mechanism side of the computer laptop, the top of the image of the Dell logo, image 1502, differs by 180 degrees of rotation from the Media Screen in image 1501. In other words, and as noted elsewhere in the application, media can be rotated or oriented in any direction by the user's command or discretion for placement on a Media Screen or screens.

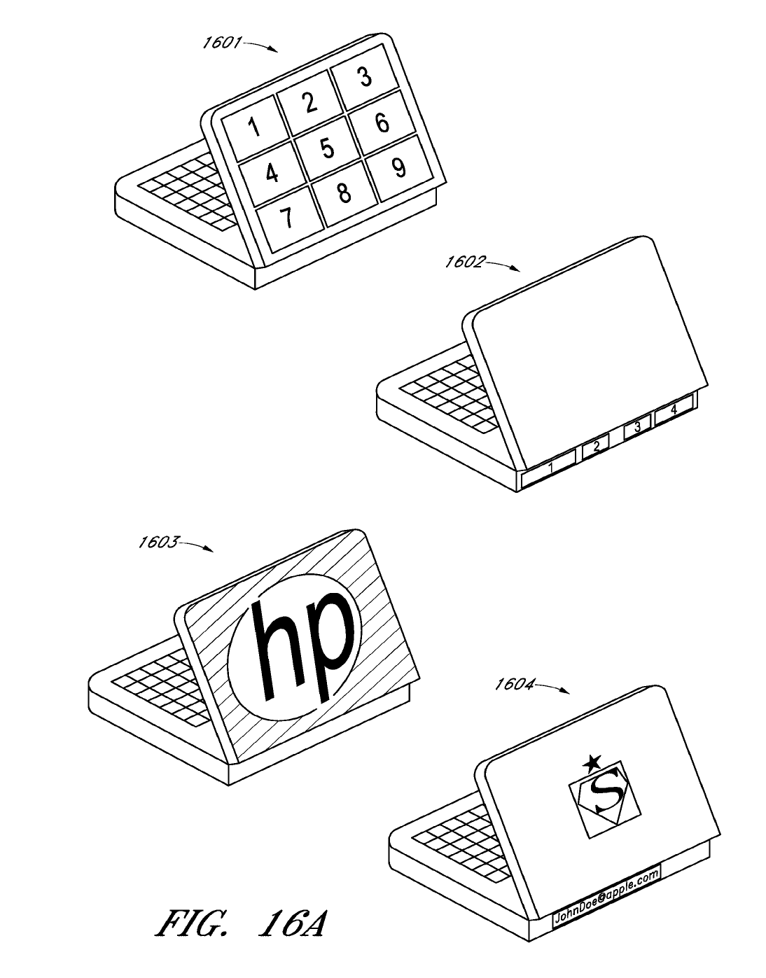

FIG. 16A shows four top view images of a half-open MediaBook. Image 1601 shows nine different places, numbered 1, 2, 3, 4, 5, 6, 7, 8 and 9, where a Media Screen or screens can be placed, inserted and/or embedded for the purposes of media display on the most visible part, or top half or cover of the external encasement of a MediaBook. Image 1602 shows four different places, numbered 1, 2, 3 and 4, where a Media Screen can be placed on the rear side of the lower half of a MediaBook. These Media Screens shown in image 1602 can be used for several purposes of media display/play/projection, including name identification or ownership designation such as product serial numbers and other data that relate to the origin of the device and/or its owner's or issuer's identity. Image 1603 demonstrates that in some embodiments, the majority of the MediaBook's external shell or encasement can display images, colors and or media; in this case the Hewlett-Packard logo. It also has an identifier Media Screen, saying “ID Here,” in the side corner of the lower half on the rear of the device. Image 1604 shows another way Media Screens can be deployed for the purposes of identification, where an e-mail address, “JohnDoe@apple.com,” is listed on the rear mounted Media Screen located on the backside of the device, a device (1604) that has a Media Screen on the top external half that is built and can illuminate an image or images of choice, in this case the Superman logo and a star design above it. Also, the Media Screen or screens deployment/placement possibilities of the MediaBooks shown in image 1601, 1602, 1603 and 1604 can be configured in any of their possible combinations in an embodiment or embodiments of the MediaBook. One potential device can have as many as twenty or more screens integrated both inside and outside the MediaBook. For example, a Media Screen or screens can be affixed in the regions surrounding the MediaBook's keyboard, monitor screen, on both sides of the outside cover of the device, the area on the rear of the device where it hinges open and closed and the three other sides one can see when the MediaBook or laptop device is closed. Further, the majority or entirety of the frame that one sees when the laptop is open around the monitor screen can come alive with various media, assigned downloads or streaming content from a selected or designated provider, such as in the case of a device branded and issued by a particular entity like Marvel Comics.

As described, elements of the images 1602, 1603 and 1604 demonstrate that a Media Screen can serve as an identifying marker for an individual device owner, or device issuer such as a company or any type of brand. The identifier Media Screen can be secreted to a remote spot, such as the bottom of a device, or displayed prominently such as on the top, or most disposed, side of a device. The Media Screen or screens used for this purpose can be dimmed, or turned off, so that the name and/or identifying information is not permanently illuminated, or only illuminated by the device owner's choice, or special command key. As in other embodiments of the devices, the Media Screen can be as small as a ¼ inch by ¼ inch and up to sizes that have dimensions one inch, two inches, three inches, four inches, five inches, six inches, seven inches, eight inches or longer. As in other applications, the Media Screen or screens for display can be of any shape and they can be raised, inset, or offset to the surface of the device to facilitate placement. In some cases, it can have associated audio capabilities that are activated via the account management system, special command, or command key. The Media Screen or screens can even blend into the design of the device so that the identity of the Media Screen is concealed when not illuminated. The user can power their display Media Screen or screens via the unit's battery, or, in some embodiments, this identifier Media Screen can have a separate dedicated battery that is concealed in the MediaBook but which can be recharged when the laptop unit itself is drawing power from an external electric source such as a wall socket. In addition, there can also be a special connection, button, command key or insert hole where someone can activate the identifier Media Screen or screens without having the benefit of available power to the rest of the device. This independent and/or special circumstances activation access can potentially allow an individual to determine the owner, issuer or an entity in charge of the device for the cases when the identity of the device is not clear. Identifier information, in some aspects, can be password protected or encrypted so that its contents can only be accessed, changed or altered by the owner of the device. This protected identification attribution can be done in the account management system, software installation/set-up, by the issuer, manufacturer or any appropriate party in the chain of sale or custody of the device.

Image 1603 in FIG. 16A demonstrates that the Media Screen technology can be licensed to other manufacturers for the purposes of resale, bundling or other commercial concerns. In such instances, the devices can be branded according to the specifications of the customer with respect to logo placements, lettering, features or matters of customization or branded content distribution. For example, Hewlett Packard can license the technology and outfit their products with Media Screens that feature their logo or manufacture Media Screens in the shape of their logo and install them on a device or devices. In this hypothetical relationship, Hewlett Packard can manufacture a MediaBook laptop computer that has an externally mounted Media Screen that is in the shape of their HP logo that illuminates when powered and on the inside of the same laptop computer, the user can have access to a cartridge released Media Screen and also a Media Screen or screens that are embedded in the inside frame of the laptop. Licensing and other commercial relationships can pertain to matters of features on devices as well as applications developed for the various embodiments of the devices and in the corresponding account management system. Variations in the devices can be offered via different types of microprocessors, memory, display resolution characteristics and performance configuration/criteria.

The MediaBook can be of any size and shape, with the logical embodiments being square and rectangular. In some cases, a MediaBook can be oval shaped or a many sided FIGURE whose design can also be aesthetic, ergonomic or designed to resemble an icon such as a logo, image or familiar object. The Media Screens can also be square, rectangular, oval shaped, triangular shaped or cut/designed/shaped in the specifications of logos, characters or icons as demonstrated in FIG. 16A. For example, Dell can have a relationship with the National Football League (NFL) and create a line of football themed MediaBooks where the color schemes of its franchises and their team logos and/or the NFL shield logo were featured on a variety of laptop, or MediaBook, products. One hypothetical Dell-NFL MediaBook can feature a silver/black color scheme where there is a Media Screen that can display the Oakland Raiders famous eye-patch logo, and/or where the Media Screen can be manufactured in the shape of the team logo on either the exterior cover or inside open portion of the MediaBook. In the Raiders-Dell licensed relationship example, there can also be Media Screens that are silver and black stripes that circumnavigate the MediaBook, or portions of the MediaBook, or other similar branding efforts placed on the proposed device.

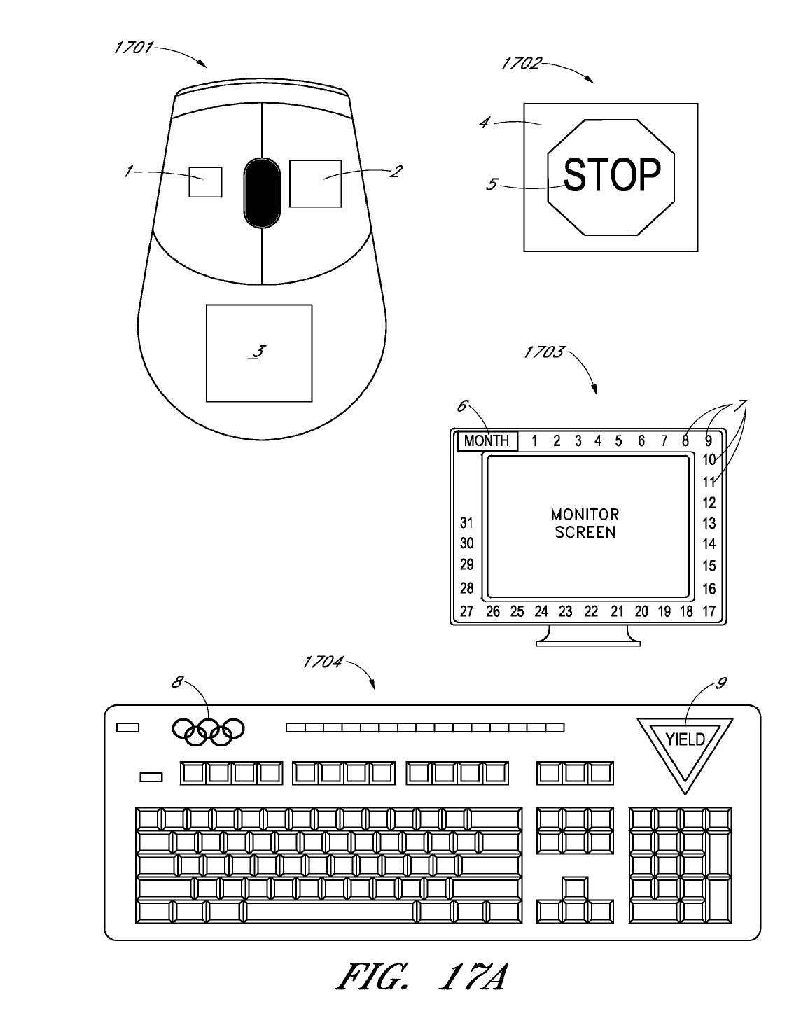

A device's Media Screen can be as small as a quarter of an inch on all four sides up to ½, ¾, 1, 2, 3, 4, 5, 6, 7, 8, 9, 10, 11, 12 or more inches per side and all of the size ranges in between as the designed device can accommodate. For example, in FIG. 17A, the Media Mouse depicted in image 1701, has three Media Screens. The first Media Screen, number 1, is a square of four equal sides of a quarter of an inch. The second Media Screen, number 2, features four equal sides of one half of an inch and the third Media Screen, number 3, features four equal sides of one and half inches. Media Screens can be affixed or embedded into the device or devices where the Media Screen can be flat, curved or rounded to fit the contours or design of the device, often surrounded by the plastic shell or supporting frame of the device. The Media Screen or screens can be of any length, width or height ranging from a quarter of inch to twelve inches and they can leverage LCD (liquid crystal display), LED (light-emitting diodes), OLED (organic light-emitting diodes) technology or other projection/display transmission technology fashioned from material taken from a group consisting essentially of but not limited to glass, plastic, plasma, organic molecules, organic compounds, polymers and/or other projection/display capable materials or components that can facilitate display in an active or a passive matrix or other form of visual display. The Media Screen can be square, rectangular, circular, triangular, spherical, cubic, pyramid shaped, diamond shaped, star shaped, mounded, tetrahedral, oval, elliptical, trapezoidal, shaped as a parallelogram, five sided, six sided, seven sided, eight sided, nine sided or ten sided figure. Image 1702 depicts a Media Mate with an eight-sided Media Screen, number 5, of a “Stop” sign surrounded by a plastic area, number 4, which is represented by shading. In image 1703, a hypothetical Media Monitor that displays the month and date has a rectangular Media Screen for the month, number 6, and a Media Screen of each day of the month, number 7. Image 1704 shows two other shapes of a Media Screen as depicted on a Media Keyboard, the famous Olympic Rings, number 8, and a triangular “Yield” sign, number 9.

In some MediaBook embodiments, the mouse touch pad used for scrolling can also be a media display space. The media content display capabilities can also be featured as background art of the keyboard. Additionally, if a user damages a Media Screen, or other part of the MediaBook, it can, in some instances, be replaced similar to replacing another working part of the computer. For example, if a Media Screen gets bumped, scratched or wears out, it can be removed for cleaning, maintenance, replacement or upgrade.

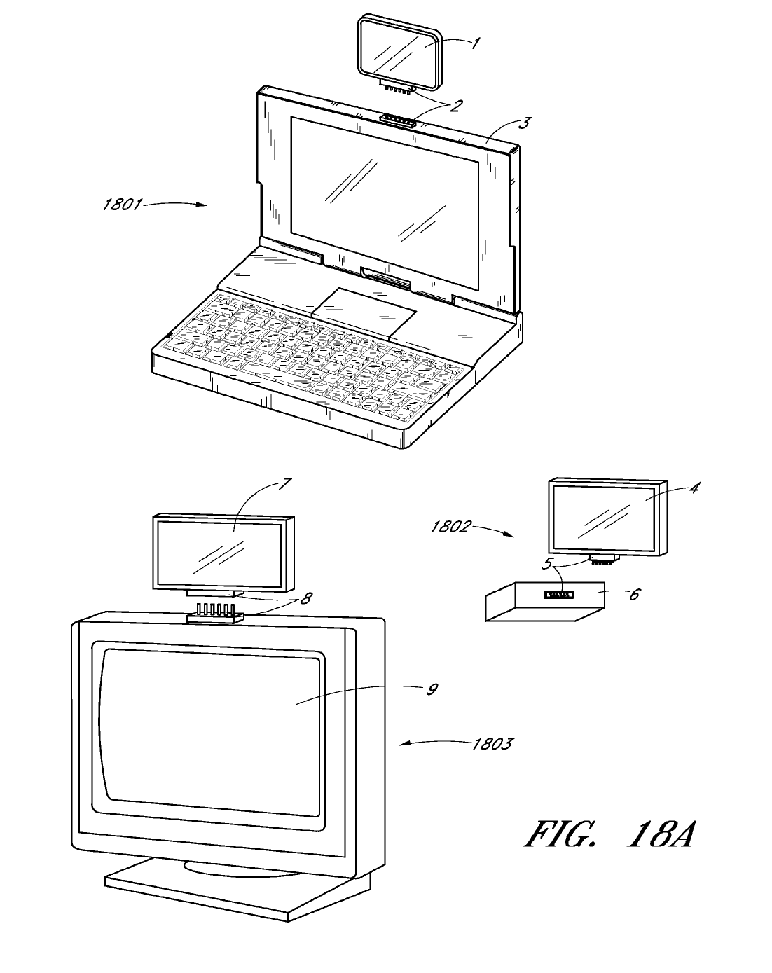

As shown in FIG. 18A, some devices can plug directly into other devices, such as a Media Monitor, or MediaBook. In image 1801, Media ScreenMedia Screen, 1, plugs into, 2, the top half of an open MediaBook, 3. In image 1801, the connection can be, for example, via a USB, in which case the Media Screen can draw power and connectivity from plugging into the laptop or MediaBook. The Media Screen or screens are not limited to any particular placement on a MediaBook; they can be on any side and they can either plug in flush to the surface, extend from a base or be on the end of an extension support structure that can be straight, angled, or bendable depending upon the design of the particular Media Screen. In some embodiments, the Media Screens can be interchangeable and even disposable. The Media Screens can also communicate wirelessly via a technology such as Bluetooth. In image 1802, Media ScreenMedia Screen, 4, plugs into, 5, its supporting Media Mate base, 6. In some embodiments, this Media Mate can be powered by USB, batteries or by an independent power source such as a wall socket and it can communicate wirelessly with a CPU and/or other computing devices. In image 1803, Media ScreenMedia Screen, 7, plugs into, 8, a flat screen Media Monitor, 9. By plugging into a device, the new device can draw power from the other device and also provide a rigid structural support from the placement via a connection, whether it is a traditional USB multi-pin or some other male-female version of connection that accomplishes a similar objective. This plugging of one device into another is not limited to the devices depicted in these drawings, nor is it limited to the areas depicted on the devices shown in FIG. 18A. In some embodiments where Media Screens are attached to devices, laptops and computing systems (including Netbooks, handhelds, video game players, PDAs and other similar products), they can be placed elsewhere in other designs and any can feature the extension technology where the Media Screens are placed at the end of structures allowing them to be placed in visibly advantageous positions to the user. For example, the screens can be attached to the end of an elongated extension member. The screens can also be attached in a manner that permits them to rotate in any desired direction.

Some Media Screens can include the entirety of the available visible exposed surface area of the device or comprise only a fraction of the device's visible exposed surface area. Some devices can be divided into regions, quadrants, or target display areas, which are selected by the user for specific designs, downloads or other type of transmission, broadcast or media selection for personalized display or content distribution.

In a specific example of personalization, the devices represented in FIGS. 2A, 3E and 3F, for example, are divided into four parts where the left click button, right click button, base and main shell directly below the left/right click buttons are four distinct display areas, effectively compartmentalizing the device into four separate Media Screen regions or quadrants that can be accessed individually or in any combination. A user, for example, can create a multi-color design by transmitting one different color to each quadrant and give the entire device a “psychedelic” appearance. Another option can be to access an existing image or file that represents a psychedelic theme and assign or download it to the entire device or any combination of Media Screens the user selects. Another option to display a psychedelic design on the device is to design it in the “create” function of the account management software, an application where users can paint, draw, assemble, mix or otherwise design their own artwork to save in a file or folder and then appear, at the user's direction, on the target device.

The device's account management system can be password protected and can advantageously provide a device user with an improved ability to personalize, decorate or adorn a workspace or area related to a MediaBook laptop computer or computer peripheral such as the Media Mouse, Media Keyboard, Media Monitor and Media Mate. The same account management system can feature applications created organically by a user community in an open source environment, by licensed developers and also by companies wanting to distribute their content by writing their own accessible, downloadable applications and by combinations of efforts to put devices in the hands of users. For example, eBay could develop applications to allow their users to track auctions, bids, payments, products, deals, promotions, events and other company specific activities. eBay could even merchandise their own line of licensed devices that are specifically configured for their proprietary processes or community based activities. In other words, eBay could preload devices with specific applications and they could also offer the applications via downloads on their site to promote use among device owners who did not get their devices through an eBay channel or offering. Similarly, other service based companies and content providers could leverage opportunities to merge their processes into the distribution channel offered by one of the enabled devices. The system can manage the display enabled entities together, or separately. In some cases, it can also integrate to functions on a computer system such as audio, or developed with respect to other popular application programs such as Microsoft Word, Photoshop, video games and other software publishers' offerings. The software can be delivered via an Internet source, via a CD that is bundled in with the device, or from an OEM relationship where the driver, or related licensed driver, is already installed onto the computer's operating center and/or CPU. Additionally, the devices can be updated by successive releases that are available via updates from an Internet source or conventional methods such as CD's. In some embodiments, any of the devices can also house and deliver the necessary software and related updates to their corresponding account management system in a transfer once connected and detected by the CPU. The management software can be set up with a desktop icon, including a shortcut, and/or placed in traditional operating system management categories, such as accessed in Microsoft's “start” icon that one finds in the lower left corner of computers that run their operating systems. Additionally, the Media Mouse can also have a system management command that is programmed into its “right click” command key.

In another embodiment, the media enabled device can provide information to the CPU upon initial connection that allows the CPU to automatically configure the media device for content display. For example, the CPU can receive operating instructions from the device (in the form of object code compatible with its operating environment, or a high level, platform independent instruction set such as java or C#, or any higher level language the system chooses to support). In this embodiment, upon the first connection between the host CPU and the media device, the host system requests instructions from the media device, which are then transferred by the media device to the host system. The host system then begins executing these instructions. In one embodiment, these instructions cause the host system to retrieve content for the media display and begin displaying it as appropriate. Alternatively, these instructions might cause the system to retrieve a more complete set of instructions from an Internet site (via for example, a URL specified in the instructions). This can cause the host system to download a complete account management system for example, which would then be installed on the host device. The account management system would then control the media device as in previous embodiments.

In an alternative embodiment no instructions may be downloaded from the media device itself. Instead, the media device simply may provide a “boot url” to the system. This boot url specifies a location from which the system can obtain the very latest set of instructions. The host system then can download the instructions from the location specified by the url. This embodiment may have the advantage of eliminating any statically hardcoded instructions on the media device, freeing up memory space and reducing media device cost when compared to the previous embodiment. Additionally, this embodiment can ensure the very latest version of instructions are downloaded (since it may always be available via the boot url), whereas instructions statically stored on the media device may become out-of-date, increasing the possibility of users encountering previously known and corrected product defects in the instructions. This embodiment can have a disadvantage in that an Internet connection is required when the media device is first connected so that instructions can be obtained. However, given most media device content will also be sourced from the Internet, this is a relatively small disadvantage.

An alternative embodiment provides that the media device sends a “device identifier” to the host system upon connection. The device identifier can uniquely describe either a particular model of media device (for example, Cyberdine Systems, Inc. T1000), or a specific media device (via inclusion of a serial number, or similar). Through separate means, the host system has an account management system installed that can be specifically designed to manage the particular media device identified by the device identifier. Upon initial connection, a relationship between the media device and its matching account management system can be established. The account management system is then able to immediately begin displaying content on the media device. Note that in some embodiments the sequence of account management system installation and media device connection to the host system may not be important. A connection between the account management system and its matching media device can be made if the account management system is installed first, or if the media device is connected and then later the account management system is installed.

Once accessed or opened, the account management software system can offer the user the opportunity to view a device's properties, security data, options, make changes, order applications, schedule alerts, manage lists, implement features, respond to offers and queries, create and edit files, research and review the capabilities of the device and get help in using and/or understanding its operation. In some embodiments, operators can direct user reference or help tutorials to be displayed on a Media Screen in or on a specific device. The devices' account management system can be intuitive and feature a mix of visual, textual and hyperlinked guides to assist users in installing, configuring, programming and operating their devices. For example, if a system user wanted to access a device, he/she can log into the online account or open the software program loaded onto their computer and then choose from the relevant icons, such as Media Mouse, Media Keyboard, Media Monitor, MediaBook, Media Screen and/or Media Mate, which can appear. Another way the devices can be selected in the account management system is by leveraging a “checkbox” system where the device user/operator merely “checks” the box next to the device that he/she wants to configure and target for personalization efforts, e.g. media assignments or downloads or broadcast enabling and scheduling. Furthermore, video user instructions of a device can be displayed on a Media Screen of one of the said devices to assist in programming, operating and/or leveraging its capabilities. Additionally, similar instructional functionality can occur; where a user displays or broadcasts the “tech support” of a non-related program or application, Microsoft Excel for example, on a Media Screen of one of the devices while he/she works on a Microsoft Excel file on the main computing apparatus.

Another operating icon displayed and/or accessed in the account management system can be one showing the devices linked together as a system with a description “Integrated System” or something similar. The integrated system icon can appear, meaning the operator can pick a configuration that allowed design work to commence to one, two, three, four or any combination of connected, and similarly enabled devices. This can result in users thematically integrating all of their peripherals via the content management system. For example, a Tiger Woods fan can have a media file of Mr. Woods swinging a golf club in a “flip-book” application around the enabled perimeter of a Media Monitor, display a static image of Tiger's famous celebratory first pump as the background on the Media Keyboard, display Tiger's logo on the Media Mouse's Media Screen and have a Media Mate stream highlights of his past shots and putts. In turn, Tiger Woods, or one of his licensees, could offer content to a variety of display enabled devices, even offering suggested integrations of content forms and special distribution opportunities. In another compelling personalization option, one can celebrate the fourth of July by framing the Media Monitor with a collage of well-known patriots, turn the Media Keyboard into an image of Old Glory through the background display feature and the Media Mouse can display an image of the Washington Monument while the Media Mate runs a slideshow of patriotic images the he/she created for the occasion. Other functionality can be to turn any combination of the devices black and orange for a Halloween mode, or Navy Blue and Gold for fans of the University of California, Berkeley or the University of Michigan. These color combination techniques can be accessed in the software operating management system of the device and either pre-loaded in a menu of options or designed by the user with the create and design tools.

In the account management system, a device user can leverage a “create” function where an image can be drawn, assembled, devised or digitally constructed. In “create” mode, a user can design or develop a file of work that can be inserted into an existing picture or image. For example, a person can take an image and apply a background color, or theme to it, in essence, layering an image, file or document with colors, other images, insertions and/or a combination of such additions. For example, if someone had a picture of their Saint Bernard dog and they wanted to put a background image of the famous Swiss Matterhorn mountain peak behind it, they can use a picture of the Matterhorn as the base photo for the new image and then ‘place’ the picture of their St. Bernard dog in front of it, or on top of it, effectively layering two images to create one. Additionally, they can find a picture of a barrel and edit it so that it can be ‘placed’ around the iconic dog's neck, which would then be layering three images to create one. In other words, there are many editing methods and options to artwork, images and media that can be displayed/played on a Media Screen or screens of a target device. The capability to select an image and insert additions to an image or delete substance from it can be performed, in some embodiments, in both the “create” and “edit” modes of the software account management system. Common terminology such as “background” and “foreground” can be used to assist the user in editing media applied to a device by the device operator. Once a desired image or clip of media has been satisfactorily delivered to the device, the user can save it to a separate folder or file that can be accessed via the account management system or stored in common text, image or media folders.

Once in the account management system, the user can choose an assortment of commands or functions: browse, create, design, write, access Internet, download to, download from, edit, save, store, save as, insert, view, options, preview, print, send to, among others. After an action has been selected, the user can then preview, edit or send the media to the device or devices. Additionally, there can be a special “shortcut” function that can prompt the user with an immediate device destination for a piece of media. This allows the user to proceed to the corresponding “browse” box and select from any source on the user's computer, e.g. any drive, folder, file, document or other accessible source such as a web page, select the desired content and send it to the device. Furthermore, when an article of media has been identified or selected for transmission to a device, the software can send it to the visual preview icon that is a part of the account management system. There, on the main computer screen of the host computing apparatus, the user/operator can view the media as it would appear on the target device. The user can then accept, reject, edit or modify that piece of media. The user can also bypass the “preview” step and send the selected media directly to the desired target device to be saved on a Media Screen.

In some aspects, a feature can be described in terms of commands in the account management system. For example, the devices can display images in a “slideshow” or in a “Flip-Book” style, which is an ordered sequence of images that can appear to move and reflect an act, feat or timeline such as the construction of the Eiffel Tower. “Collage” can be a command function that a user can access on any of the devices that allow multiple images to be affixed to the device, sometimes in a predetermined layout. The images can either be inserted into areas fitting a prefabricated outline of a collage, or they can be layered on top of one another to create a random collage design. Also, a “movie” or “film” command option can allow a user to assemble, create or edit clips of moving pictures for display on appropriately enabled devices. Similarly, a “mash-up” command in the account management system can allow for the integration of separate forms of media into one image, file or piece of media and that can be downloaded to appropriately enabled devices.

One feature of the software management system can allow device owners to choose from an inventory of preloaded content that can be thought of as similar to “clip art” that one finds in popular word processing, artistic, photographic, design and desktop publishing applications and other related software. It can be accessed and navigated in a demonstration form, visual form, or through icons that correspond to popular topics or themes such as “nature,” “architecture,” “animals,” “flowers,” and other similar generic terminology. Other preloaded content can correspond to more specific subjects or categories such as “seven wonders of the world,” “flags of the world,” “Olympic heroes,” and other topics of interest. Another key function can be a basic search mechanism that can find and sort media content, user tips, help with device operation, file management and integrating media for display, play or use.

The devices' account management system can allow device users to receive transmissions of media from outside sources, or individuals, to specific devices. In these instances, the account management system can allow the user to direct certain media from the device to the main computing apparatus and/or CPU and save it to a disc, drive, file, folder or other storage entity that exists in connection to, or in service of, the host computing system. Additionally, device users can broadcast a live feed such as a sporting event, news headlines, stock ticker or RSS to a device, devices or a specific Media Screen of a device. There can even be subscriptions that one registers for which can send media such as broadcasts and/or dynamic streaming content to a particular device or devices when they occur. For example, an individual can have updates of his or her stock portfolio sent by a brokerage service, or financial media entity, to a Media Screen on a device on a time basis, such as hourly or every two hours or at the opening and closing bells of the market. In other words, a user can see how each individual stock, or fund, or portfolio is performing at the times of day the user chooses. Furthermore, display enabled devices can be developed specifically with this application emphasized, meaning that a Media Mate, Media Mouse, MediaBook, Media Monitor or Media Keyboard can be developed by a financial services related firm for the purposes of reporting an a client's investments of interest. This subscription service can apply to any content, news or notification type entity, including the package delivery business, and it can be managed and accessed in the account management system of the device or devices.

The devices can have integrated functions or applications that enable the device or devices to have calendaring, alert, alarm and recognition functions. In other words, a user can program a device with timekeeping functionality so that the user can input scheduling data so that the device can remind users of appointments, meetings and other milestones, time related and otherwise. For example, a user can create a buddy system, or a preferred user-list mechanism that identifies individuals who have sent an e-mail to a person who designates a target device for this alert purpose. When activated, the target device can serve up an image or other media (e.g., audio sound) that corresponds to the individual who has sent the e-mail. For example, If Mr. John Doe's daughter, Jane, e-mails her father, then a picture of Jane Doe can pop up on Mr. Doe's chosen target device or devices, including a specific Media Screen on a MediaBook, to alert him that his daughter has just e-mailed him The arrival of Jane's e-mail can also be represented by a different icon, such as a logo, picture, image, text, computer file, song, sound or any combination thereof that Mr. Doe chooses to associate with correspondence from Jane. Additionally, Mr. Doe can restrict the e-mail display functionality to certain addresses and identities by filtering his preferences with respect to that buddy list functionality. Mr. Doe can also turn the application or function completely off and enable it entirely upon whim, consideration or desire.

Another variation of the embodiment can be to have the Media Screen on a device provide a window to his e-mail Inbox, where his most recent e-mails are listed. The emphasis of the application being that the user has the ability to personalize the reminders of those who e-mail the device or device's owner in addition to the manner in which he gets alerted by correspondence of friends and prioritized contacts. For example, one person on a buddy notification list can be identified by a personal photograph and another individual can be identified by a iconic logo of a sports team, a third person can be associated with a sound like a ringing bell and a fourth person can be associated with a famous landscape portrait such as the Grand Canyon, combinations of sounds and images, etc.

Additionally, the devices can be synchronized with popular social media networks such as Facebook, or popular communication tools like Twitter, where communications, updates and content can be directed to designated devices or Media Screens on devices. The service providing companies such as Twitter, Facebook, eBay, MySpace, LinkedIn, and any other can either push their services and/or products to devices via widgets and applications, or developers and individuals can pull the capabilities to them via widgets, applications, and methods of creating and accessing them. Further, unique devices and/or entire applications and functioning widgets can be created, written and distributed for specific products and services from companies like eBay, Twitter, Facebook, the like and any other brand. Examples of how the described capabilities can be accomplished are described more fully elsewhere herein. In some aspects, widgets and applications that can apply to the device or devices can sit in a folder, or on a desktop or via a intuitive search and retrieve system or be synchronized in a user friendly manner in the User Interface or application field of the account management system. The synchronization also applies to programs such as Microsoft Outlook, Outlook Express and individual e-mail services such as Gmail, Yahoo Mail, AOL and Hotmail. Another type of functionality can be where ‘texting,’ or the popular transmission of text messages, can be directed to a Media Screen or screens on a particular device via the common methods used in cell phones, handhelds, PDAs and similar devices.

Additionally, an embodiment can integrate the alerting and buddy system classification into a thematic design such as a Media Mouse or Media Mate built in the shape of a police squad car where a meeting that was scheduled can be signaled by a flashing red light and siren sound with a picture, name or icon of the person appearing on a screen, or even in the back window of the police car themed device. Another application of this police car embodiment can be an e-mail coming into a user's Inbox and the red light blinking/flashing and/or a siren sounding to announce its arrival, or the windshield being a Media Screen that displays an announcement of the message's arrival. Furthermore, the calendaring and reminder application associated with the device or devices can have the same options where inclusion or exclusion is determined by the user via the master account management program where the properties are defined in understandable fields that allow the user to opt into, or out of, desired functions and features. For example, a user can go into the account management system and leverage a capability where the user permits or authorizes people to send media content directly to a device the user operates. This can be done through a buddy list or other directive where the individual can direct his Instant Messaging, or ability to receive text messages, to a Media Screen or screens to a target device with a Media Screen or screens. Other commands can include directing a specific program application, such as Microsoft's Media Player, to a particular device.

A further calendaring capability that the account management system can offer is to access, deliver and serve dynamic content that the user can program into a device or devices. For example, a Media Keyboard can be programmed to change its display image every one, two, three, four, five, six, seven, eight, nine, ten, eleven, twelve, thirteen, fourteen, fifteen, sixteen, seventeen, eighteen, nineteen, twenty, twenty-one, twenty-two, twenty three, twenty-four hours or at any of the sixty minutes in between those hours. One option, for example, can be to program a “word of the day” function where a different word showed up on the device in twenty-four hour intervals. The source can be a file, web site, e-mail delivery, program loaded onto a drive or similar application. Once implemented, each day a new dictionary word can appear on the screen, complete with definition, etymology and other descriptive features. The user can further select the time and duration of the ‘word of the day’ being displayed. Another option can be to prompt daily occasions with icons. For example, sunrise can feature a crowing rooster, 12:00 PM can feature a picture of Gary Cooper in the film High Noon, and 5:00 PM can be cartoon icon Fred Flintstone sliding down the back of a dinosaur to signify quitting time and 10:00 PM can be a snoozing baby. The device's user can also program the device to select new images from specific folders, or user designated display lists, on a specific timetable, e.g. a new picture from a specific list or folder every four hours. In this ‘every four hours’ example, assuming that the folder selected, or list created, for display on a target device contained pictures of family members, then every four hours a new photo of a family member from that folder or list would appear on the device, or designated parts of the device that the user had selected. As indicated, users can also create lists or files of photos, images, video, media and integrated combinations thereof to appear in various sequences, or even in “shuffle” mode, an option that randomly selects one item for display at predetermined intervals.

In a more generalized embodiment, software applications can direct their output or a portion thereof, or receive their input or a portion thereof, from particular enabled displays. For example, a Media Screen might display all instant messaging traffic received by a particular user. Alternatively, notifications of new e-mails can be received on a Media Screen, while the user responds to the e-mail on their primary display.

In another embodiment, when an application is using a Media Screen for output purposes, the Media Screen also includes input means for the application. For example, a Media Screen might employ touch-screen technology, wherein after an e-mail notification is displayed on a Media Screen, the user can touch the Media Screen. In one embodiment, the touch causes an application-specific response on the computer's primary display. For example, perhaps the main window for the e-mail application becomes activated and is brought to the foreground. The received e-mail is highlighted in the inbox, and its contents displayed in the preview pane of the e-mail application. This action allows the user to easily read and respond to the new e-mail based on a simple touch of the Media Screen.

In another embodiment, the touch of the Media Screen causes a notification to the computer's operating system. The operating system may provide for a standard response to such a notification (for example, activating the application's window on the primary display). This embodiment provides for a consistent response to Media Screen input across all applications. However, even in this embodiment, the operating system might also provide means for the application to customize the response to such a notification.

In other embodiments, Media Screens provide input devices that are not touch-screens. Media Screens might be manufactured with buttons located close to the screen or otherwise with a clear association to the Media Screen. Touching a button associated with the Media Screen sends a notification in a manner similar to how a touch-screen would send it above. A Media Screen's input device is not limited to buttons or touch-screen technology, but might incorporate dedicated touch pads, pointing devices, individual or groups of special purpose keys or buttons, sliders, knobs, keyboards, joysticks, etc. Note also that an input device's association with a particular Media Screen can be via its physical proximity to the screen, but might also be made apparent to a user via color, markings, labels, shapes or other means.

In another embodiment, the Media Screen's input means (button, touch-screen, etc.) cause a redirect of an alternative input device to the application associated with the Media Screen. To demonstrate, consider a Media Screen that displays instant messages received by a particular user. Simultaneously, the user is interacting with a different application (for example, e-mail) on the computer's primary display while utilizing the computer's primary keyboard. In response to a particular instant message displayed on the Media Screen, the user touches the Media Screen's input means (touch-screen, button, etc). The user's touch redirects the computer's primary input device, (in this case a keyboard), to the instant messaging application using the Media Screen. Subsequent keystrokes on the keyboard are now displayed on the Media Screen itself (and not on the primary display in the e-mail application).

When the host electronic device has several input devices, a redirect signal from a media device can cause the redirect of any of those input devices. For example, while the keyboard is used in the example above, a Media Screen redirect signal can also redirect input from a computer's mouse, touchpad, joystick, camera, or any other input means. Which input device is redirected can be based on a number of factors. For example, the application utilizing the Media Screen may dictate the input device. A keyboard may be redirected for character based applications, while a pen peripheral may be redirected if a graphics oriented application is utilizing the Media Screen. To support this embodiment, the operating system or other software application may provide an API that allows an application to set the input device needed when a particular Media Screen input means is triggered. This reduces potential conflicts between applications attempting to utilize the same input device.

In embodiments including input device redirection, some alternative input means (the Media Screen or other computer input, for example, a key or key sequence on the keyboard itself, mouse input, etc.) can restore the redirected input device back to its original use after the user has completed their interaction with the Media Screen application. The operating system or other software application may provide an API that allows the Media Screen application to release the redirected input device without requiring it to know which other application should now again receive input from that device (if any). Alternatively, the input device redirection can be transparent to the Media Screen application, with the Media Screen input means serving primarily as a signal to the computer's operating system to activate & deactivate the Media Screen application. Thus, deactivation of the Media Screen application is accomplished through preexisting operating system paradigms.

Configuration of the previous embodiments can take a number of forms. Of course all forms must define which applications are utilizing which media displays and input devices at all times. In one configuration embodiment, applications request output devices by name. For example, a stock trading company utilizing a Media Screen to display a stock ticker might publish a software application. The application outputs the ticker to a media display with a device identifier of “Stock Trading Company ABC's ticker display.” If such a display is connected to the system, the information is written to the device and content is displayed, otherwise, no information is written.

In another configuration embodiment, a display configuration subsystem, perhaps but not necessarily included in the computer's operating system, provides a central location (in the “control panel” for example) where application and display devices are “matched.” For example, a user might configure their e-mail application to send new e-mail notifications to the display attached to the top of their primary display, while instant messages go to the display attached to the right side of their primary display. In this embodiment, applications are aware only of writing information to a display other than the primary display, but do not write to a specific media device.

To enable this embodiment, several API's between the display aware applications, the media displays themselves, and the configuration subsystem are possible. For example, an application might “register” its ability to output content to a secondary display with the configuration subsystem. Media displays might also register with the configuration subsystem when installed (via their device driver or account management software), or the operating system itself can register the media displays based on the device identifier or a “capabilities list” provided to the configuration subsystem by the media display upon the initial connection.

When the user later consults the configuration subsystem's user interface, a list of applications and a list of media displays appear. The user can then assign a display to each application.

Default configurations can also be provided to reduce the configuration burden on the user. “Smart defaults” are enabled by the registration of “capability needs” by applications, while the displays register (directly or indirectly) a “capabilities list.” The configuration subsystem can then better match application needs to media display capabilities to enable the smart defaults function.

Note the potential for inefficiencies or conflicts in this embodiment generally. i.e. when the application is not running, a media display assigned to it risks going unutilized. However, allowing several applications to use the same media display risks conflicts between applications for a display resource. Resolving these issues is a matter of policy, with the appropriate trade offs understood in the art.

The Media Screen or screens display technology and account management system software can also apply to printing, scanning and fax devices. For example, a Media Screen or screens can be visibly disposed on the external encasement of a device that specializes in one of those tasks, or all of them, for personalization and identification purposes and also as a preview to a print, scan or fax job being executed. Further applications include applying at least one extra display, or Media Screen, to a television set, or at least one Media Screen to other home electronic device.

The device, or devices, can be interactive and receive technical upgrades, promotional offers, special artistic designs, licensed images and user management tips from an Internet source or other source such as a special CD. These can be offered gratis, for purchase or bundled into a commercial association with a third party. For example, a device can have a third party promotional agreement where a designated licensor or entity can appear on the device and say, “Hello, ______ (name of device owner). You have just won a $100 shopping spree at ______ (name of sponsor business).” This can also be a celebrity spokesperson saying or texting “Happy Birthday, ______ (name of device owner)” or “Congratulations ______ (name of device owner). You have just won front row seats to my concert this Saturday night.” Further, there can be special content relationships where the device is manufactured and designed to accentuate specific media content from a specific property, such as a sports team, athlete, singer, band, actor, licensed image, entertainment character, film, character, public personality, comic book character or identifiable icon. For example, a Media Mouse and/or Media Mate or other enabled Media Screen associated with the technology can have a Star Wars theme where Darth Vader tells the device owner, “______ (name of device owner), you have e-mail.” Or Darth Vader communicates to the device owner in his famous tone, “______ (name of device owner), you have a meeting.” The user can also opt-in or opt-out of operating applications or special promotional offerings that can involve content unique to the device or devices and its customer base. These promotional and/or personalization activities can be opted-in or opted-out depending on the preferences of the device owner and restricted to promotional activities of the device owner's choosing.

Thematic devices open up novel commercial markets where the said devices exceed the normal use standards of the common computer system and computer peripheral by acting as a new point of content distribution or communication to a computer user. For example, a Media Mate device, such as image 804 in FIG. 8A, can take the shape of a heart and be a Valentine or Anniversary or romantic commemorative. An individual can give or receive a Valentine/Anniversary/Romance Media Mate where the device can have preloaded onto it various sentimental media items such as pictures of one's significant other, even video from a wedding or other significant relationship milestone(s). The Valentine Media Mate, or other device such as a similarly themed Media Mouse, can also have an application where the device can be sent special images, messages and content from the person who gave the device to the recipient. The correspondences can be calendar driven reminders of relationship milestones such as anniversaries and birthdays, or personalized content such as romantic text messages sent on a whim. In another application, the device holder can access content that was sent to him or her via a special code that the recipient must enter into a host website, or other secure transmission medium, in order to obtain.

In other useful and novel design embodiments, there can also be information response capabilities built into the devices. For example, there can be a device that assists in testing or quizzes where a question can appear via a website or program application on the monitor screen of the main computing apparatus and the answer can be sent to a Media Mouse, or other enabled device, where the user can put his or her hand over it, or simply darken the image by programming command or even touch, only to lighten it by another programming command or touch when prepared to view the answer. Another device can be a “Happy Birthday” Media Mate where the device can be shaped like a traditional birthday cake where the “Happy Birthday” song gets activated by the giver to the recipient and the corresponding media content, including birthdays and milestones of other relevant individuals is preloaded onto the device or accessed via a special code entered at a related website or that can be configured in the account management software. In another version, an embodiment can be adapted for polling purposes where the Media Mate monitors a user's computer behavior and then communicates it back to a data collection center or facilitates a “Question & Answer” session. A branded device can even be created with a TV show such as American Idol where viewers can leverage interactive elements to vote on performers, ask questions and make song requests. In short, the devices can feature interactivity beyond the downloading and displaying of media and other content that can be an extension of the device's personalization capabilities, especially with respect to third party relationships, promotional and otherwise.

The device or devices can display open browsers to receive live content, view static and dynamic information from the Internet. One useful application can be a special “meeting” or “presentation” option where a presentation can be conducted by an individual where parts of the presentation can be directed to the main monitor screen and/or to a Media Screen on a device that has been identified for transmission and display to a web address that can broadcast the presentation. For example, an individual using a MediaBook can take part in an advertising presentation by viewing the meeting on the device's Media Screen, or on a Media Mate with a large Media Screen, while taking notes and making changes to a document that is open on the main monitor screen. Or, the same individual can watch the meeting in an open browser on the main monitor screen of the MediaBook and view reference information, such as a hypothetical ad campaign for the brand being discussed on a companion Media Mate while the individual receives Instant Messages from another participant in the same meeting on a Media Screen located on or in or attached to the MediaBook. If the user wants to respond to the Instant Message, he/she can have another browser open on the main monitor that is in the account management system of the device which authorizes/manages that action. In “meeting’ mode, individuals can sign up for a particular meeting, lecture, presentation or destination programming in advance, or enter it in real time, and assign the streaming content of the meeting to a particular device, or view it via a browser on the main monitor of the computer apparatus, while participating via the installed camera if they have a camera equipped device.

The software or account management system can also have a “store” or e-commerce aspect unique to the products and services that correspond to the various devices. This can be a medium where users buy, trade or even sell media merchandise that can be displayed on any/all of the peripherals. The items can be device specific, or categorized for corresponding models of specific devices. In this mode, “search” and “help” functionality can guide or assist users through the process of sorting, organizing and reviewing basic offers, ideas and content for their devices, much like ringtones are available for cell phones, and MP3 players are merchandised for digital music offerings. This e-commerce functionality can also be a place where third party relationships and licensed merchandise is featured, promoted and sold. Furthermore, a device user can prioritize certain protocols, relationships or content providers to a particular device. For example, a NY Yankees themed MediaBook, Media Mouse, Media Keyboard, Media Monitor or Media Mate can have a default to its Media Screen or to a particular screen or region on a target device, where a licensor such as the NY Yankees can send updates. The updates can take the form of an in-game development such as a score, or an organizational press release such as a trade or injury report. The Yankees can leverage broadcasts to the device or devices to even make a commercial or promotional announcements such as game tickets for sale, or a special charity auction of autographed merchandise. As in the other examples of licensed devices, The NY Yankees themed device can be shaped like a baseball and painted or configured to project a pinstripe design either around or on a Media Screen or screens. Another application for a device owner can be with a company to whom relevant transactions are important, such as eBay. In this example, an individual can target eBay transaction developments, or the status of various auctions, to a device or devices. The company, eBay, can even distribute and/or merchandise its own devices, or system specific software, that report real-time developments to a device. This applies to financial service firms, information services companies as well as any entity to whom the up-to-date information flow is important. Device users can also configure the reporting of real-time developments to ‘turn them on’ or ‘turn them off’ and/or other options that relate to such communications.

In another embodiment, the Media Screen can be a data destination for a specific content provider or Internet service such as Twitter or Facebook. In this type of application, the display screen can be an interface for accessing, and displaying data and/or digital content of the provider such as updates. In other words, special licensing arrangements could be made so that the Media Screen or display area could feature a specific provider's content. In this example, a content provider's server could be a source of media, data or content that is ultimately transmitted to a user's designated Media Screen on a device such as a Media Mouse, Media Keyboard, Media Mate, Media Monitor, MediaBook and/or any other enabled device. Furthermore, specially branded devices could be created wherein the manufacturing design factors in the most favorable shape of Media Screen to feature the content. For example, there could be a special device called a “Twitter Mate, Twitter Mouse, Twitter Board,” or “Tweetie Mouse, Tweetie Board or Tweetie Mate” where the device was enabled with a Media Screen or design that features the type of communications that Twitter specializes in delivering, e.g. in 140 character intervals or transmissions. For companies that provide relevant products and services, the Media Screen or display area of the enabled device could be configured to receive and display transmissions from the origin server tailored to their said products and services.

As described, the devices can come pre-loaded with substantive information or content. This pre-loaded feature can be the decision of the manufacturer, technology licensee or the result of a promotional, contractual, or independent relationship negotiated between relevant parties. The information can include operational assistance or licensed, pre-loaded content from an entertainment entity or content provider such as a music label, musical act, broadcaster, intellectual property rights holder, sports team, college or University, personality, historical figure or event, structure, or movie characters from a production company such as Disney, a film franchise such as Star Wars or feature film releases with respect to specific devices. There can also be similar relationships with publishers, educators, archivists and producers or licensors of media and information. Furthermore, the devices can have sufficient memory and microprocessor architecture for storage and display of individual files, relevant content and for the necessary operational use of the device.

Some devices can have a detachable construction where the interior of the devices can be separated from their exterior shell for the purposes of maintenance, cleaning and/or part replacement. The devices can have a single projection Media Screen, two, three, four, five, six, or seven Media Screens or be comprised entirely of a unified display element that can display media on the external surface of the device. This exterior shell, for example, can be the traditional humpback shaped mouse, rectangle of the keyboard or square of the monitor frame. It can also be a part of the thematic designs such as a football, baby crib, dog paw, heart, automobile, or other shapes in a device such as a Media Mouse or Media Mate. It can, as discussed, relate to the Media Screens in MediaBooks as well. In some detachable embodiments, the top half of the device integrates the protective exterior to the supporting bottom half framework that holds the necessary components and circuitry to execute the tasks associated with the device. In other words, a part or parts of the device can be easy to remove and maintain before replacing it in the pre-molded alignment with the circuitry to operate the device. The removable portion can consist of hard, molded plastic that fits into the fixed portion of the device and can feature sufficient temperature and microbe resistance properties so it can be properly cleaned and dried before being reattached to perform its function. The unit can be connected by simple easy to unlock parts such as clasps, locks, screws, clips, bolts, or interlocking joints that are safe and easy to operate, allowing the user to snap, pop or click open the device quickly and without inducing excessive wear over time. It can be affixed back to the circuitry and frame of the device through a variety of methods essentially consisting of but not limited to: grooved alignment, designated points of contact, or interlocking fitted parts.

In some of the devices, various control buttons that relate to functionality of both the device and even the CPU can be located on the device. These control buttons can be located on the side, front, bottom or top of the devices. In some laptop or netbook or “mini” computer embodiments, e.g. the MediaBook, certain enabled display areas or Media Screens can have separate volume or brightness related controls, controls that are accessed via the device's account management system, special buttons added to the unit and/or sound capabilities routed through to the computer's main volume control system. In some other embodiments, the devices can have a cover, partition, section or lid that protects, conceals and shields a control panel. In these embodiments, the section can flip open on a hinge or via a clasp and reveal a keyboard or other such controls that can pertain to functionality. Furthermore, the device designs can allow for space to attach buttons for functions, logos, markers, lettering, three-dimensional icons or a combination of efforts to otherwise equip and/or label the various devices. In and of the embodiments, the devices can include all or some of the required keys, command and functionality buttons/mechanisms found in most commercial keyboards such as QWERTY and other languages, including the feature buttons that pertain to computer operation, monitor adjustments, media activation and other common commands. Another capability can be the ability to perform as an alternate or “backup” keyboard to the CPU.

The devices can take on special form factors, even the Media Monitor. There could, for example, be a baseball themed Media Monitor, where the actual monitor was shaped like a baseball and the frame can contain Media Screens where there are Media Screens embedded in the architecture of the larger monitor device. Other embodiments are also possible. Virtually any sports activity (for example, baseball, basketball, football, tennis, hockey, volleyball) includes particular equipment that can be used as a form factor for a Media Screen. The form factor then signifies the type of information that will be displayed. For example, when a user plugs in a hockey themed Media Screen to a host computer, the Media Screen begins to display the very latest hockey news, scores, etc.

The possible form factors go beyond the sports domain. For example, a media display intended exclusively for financial data from a stock trading company can have the company logo printed on the case. The display can be dimensioned to resemble the scrolling stock ticker in New York's framed Times Square, i.e. just one character high by several characters long. The display might have other specialized capabilities tailored to display of the specialized content. For example, special purpose lights can indicate an up or down stock market, or special symbols can light up upon certain events (similar to a modern car dashboard's indicator lights). The closing bell might sound at the appropriate time, along with a flashing bell indicator light on the display. Thus, Media Screens can be customized to communicate the content type the company wishes to convey via shape, color, size, special display capabilities, logos, etc. Media Screen form factors can also be utilized effectively to communicate the brand image of the manufacturer.

Provision for the user to customize the information provided by the Media Screen can also be made. If the device is connected to a computer, the manufacturer can provide an application that allows the user to customize the display information on the device. Connectivity between the computer and Media Screen is established via traditional means. Alternatively, the device can expose a web based interface, allowing the user to configure the device directly (via a standard web browser). This technique is known in the art and frequently employed with network infrastructure devices. This technique does have a disadvantage of requiring more software (and thus potentially more hardware) resources on the device itself, potentially increasing costs.

Additionally, these media devices can be designed to operate independent of another computer, with only a direct connection to the Internet for support. This Internet connection can be via wired or wireless means. Configuration of the computer independent Media Screen can be done directly as described above, with the Media Screen exposing a web based interface. The Media Screen would then consult a web based server to receive content to be displayed.

Alternatively, all configuration and content updates can be centrally managed by a web based application maintained by the manufacturer. By using a device identifier, serial number, or other identifying information, a user can login to a web based application supported by the manufacturer of the “computer independent” Media Screen. Once logged in, options are presented allowing the user to customize the types of information displayed (scores but not news, news but not scores, etc). The web application can also allow the user to configure the frequency of updates. Many other features are possible via software and known in the art.

In this embodiment, the web application server would understand how to remotely connect to the “computer independent” Media Screen based on the device id (or other information) provided by the user. Several mechanisms are available to establish a connection between the Media Screen and web server. The most effective is for the Media Screen to periodically “poll” the web server, including its identifying information in the “poll” request. This mechanism works best because the web server's IP address or hostname can be established and well known at the date of Media Screen manufacture. It can thus be “hard coded’” in the device. A polling mechanism has a further advantage of avoiding problems with firewalls and proxy servers, which often sit between the web server and Media Screen, preventing a connection initiated by the Internet server. Since most firewalls and proxy servers are configured to allow http request messages, especially those initiated from the “client” side (which is the position of the computer independent Media Screen.), a Media Screen initiated connection works best.

When the Media Screen “polls” the server, the server checks to determine if it has any new configuration information. If the user has updated the configuration since the last poll request was received, the web server simply delivers the new configuration to the device via the poll response. These configuration update polls can also be piggybacked with the Media Screen's request for new content, thus improving network efficiency.

The account management system capabilities can be implemented within the media device itself. In some embodiments the account management system for a computer independent media device for the account management system can be web-based. This web based software can be maintained by the manufacturer of the media device, or licensed/authorized third party and can perform all the activities of the personal computer based version. However, the architecture for implementing the plug-ins can vary when compared to the previously discussed embodiments. The web-based application can provide a web service interface to enable content providers (or third parties) to extend the capabilities of the web based application in a manner similar to that of the PC oriented application. For example, a Facebook plug-in can be developed that gathers content via Facebook's web API and then sends the content via the plugin interface to the web based account management system. The web based account management system would then forward the content to the media device during the next poll request from the media device. Plug-ins for the web based account management system can also be provided for other web based applications such as eBay, Twitter, etc. The plug-in architecture can support additional applications in the future as they are developed.

In another embodiment, the web-based account management system can host the plug-in software, alleviating the need for plug-in developers to maintain a dedicated web presence. These plug-ins can be implemented as widgets or as other forms of Internet programming models. The plug-in developer can simply upload the executable before the plug-in is “registered.” To ensure quality, the device manufacturer may implement a plug-in certification process to ensure the plug-ins meet quality standards and will perform reliably for media device customers.

Aftermarket embodiments, some of which can be referred to as Media Mates, can be manufactured and bundled with or sold separately for use with a computer system or one of the proposed devices. These can essentially be add-ons that can be purchased for application to the outsides of peripherals, or adjacent to a computer system, that display media on a Media Screen or screens. Some aftermarket devices can be applied or affixed to a computer or workstation by the item known as Velcro or via bolt, clip, screw, specially designed joint, hinge or interlocking sleeve mechanism. In some cases, these embodiments can allow devices to be applied to the existing peripherals or computing system that does not have a Media Screen or screens as originally configured. The devices can communicate wirelessly by a technology such as Bluetooth®, be powered by batteries, via a wire or connective cable such as USB or by plugging directly into inserts that are connected to, or are a part of a frame, e.g. a multi-pin or similar connection that could be USB.

Another peripheral device that leverages a display capability can be called the Media Projector. It can be a cartridge insert or flip-out device from a MediaBook, or it could, in some embodiments, be an attachment that plugs into a multi-pin connection and projects media against external. For example, the device can project a file such as a Power Point against an appropriate surface such as a white board, wall, projection screen or relevant surface. In other embodiments, this projector device can also be an external device that attaches via a sleeve, clip-on or slides into a slot that connects to the host unit. As a standing peripheral, the angle of projection can be manipulated via an adjustable angling dial that aims the projection beam accordingly. For devices where the device is part of a MediaBook or laptop computer, the clamshell design can assist the user/operator in angling the Media Projector in many directions. Further, with its integrated software capabilities, the device can access a computer's files easily and seamlessly for the purpose of sharing the information within a room and/or broadcasting to other individuals who are in remote locations but participating in the presentation. The devices can communicate wirelessly via a technology such as Bluetooth® and can be powered by a connection to the host computer, a wire or cable such as USB, batteries, wall socket or any combination thereof.

Various embodiments of the MediaBook, Media Mouse, Media Keyboard, Media Monitor and Media Mate can be designed, constructed and equipped for the purposes of enhanced video game playing or to be connected to a video game player. For example, a Media Screen or screen on a device can be targeted for specific video game content such as highlights, files of highlights, broadcasts of game promotions, other broadcasts from video game content providers or action of others playing a video game. Also, specific embodiments of joysticks for game playing can be developed with Media Screen display technology; meaning that a video game joystick can have at least one display and the means to display media upon it, or to it. The Media Screens on the special joysticks can show highlights of the actual video game action being played in real time, broadcast game-playing strategy and instructions to the players, broadcast other games played by people, show scorekeeping, stream aspects of the game to the device, or integrate related media with individual titles, or categories of titles in mind The peripherals, for example, can transform to the theme and qualities associated with a specific game such as John Madden Football or Grand Theft Auto, or to a category of online gaming, including sports, poker, military, history, trivia, fantasy, science fiction and driving. For example, a gamer playing John Madden Football can have quips and commentary from John Madden, or individual players, originating from and playing through a Media Screen on a joystick or other Media Mate. These game enabled devices can also have their own audio features, where speakers are located on the devices, or integrated into the game console system so that the commentary by John Madden, a player, or other announcer has priority over other audio related to the game action, or is spliced in along with the other relevant sounds of the game. In other words, game peripherals can be specially designed, constructed and programmed with Media Screens for personal computers and specific video game consoles such as PlayStation®, Xbox or Wii, and the games, titles and publisher requirements that correspond to their respective platforms and related titles. In short, the peripherals can be enabled with Media Screens to add functionality and enhance the game playing experience. In the John Madden Football commentary example, this means that there can be a feature whereby the video game player enables a device with the “announcing” or “commentary” feature and a personality or representation of one can appear on a Media Screen and their commentary, observations, input and contributions correspond to the game through the Media Screen enabled device, including audio. Of course, the game player can opt not to enable the “commentary” feature and instead stream replays or highlights of the John Madden Football game action, dedicate the Media Screen to statistics or other options available in the account management system of the device.

Another aspect of the technology as it relates to video game playing can be to develop a Media Mate peripheral specifically designed for recording, announcing and editing purposes associated with actual game action. The device can be called something like “Press Box” and it can connect to the game playing Personal Computer or game console via a wire or cable such as USB and communicate wirelessly via Bluetooth® or similar technology. Once in the “Press Box” application, a user can turn a video game event into an actual broadcast or video highlight show where an individual or individuals can assume the role of announcers and describe and comment upon the action, make replays, create files for later use, compile statistics, have commercial interruption and make the experience a personalized functional broadcast. In this embodiment, Media Screens can be used for things such as different camera angles of the game action and to review editing tasks and assemble a final broadcast or file. The device can have control buttons located on it for recording, playing and other related functionality commands or it can be done in a software management program on a Personal Computer that can connect directly into, or communicate wirelessly, with the device. The software management program can also store different templates for different games and titles and enable the commentary or broadcast experience where the action is occurring via a video game console or Personal Computing device and store the files in a manner conducive to broadcasting, sharing or archiving. For example, if John and Jane Doe want to play John Madden Football against one another, their siblings Jack and Jill Doe can act as announcers and integrate their commentary and personalized production aspects into the experience, record the event, broadcast the event, save it to a file for rebroadcast and editing if desired. This means that the Doe family can archive their games, make special compilation files and keep a personalized record for posterity. Another example would be where a “Press Box” peripheral was developed for Guitar Hero® and it allowed members of the Doe family to assume the role of producers to create actual videos of game players to songs, and/or other aspects of the game and Guitar Hero experience. They could also role play as announcers to judge performances by friends and other family members and make the game into a production event where all or part of the game aspects can be edited, recorded, shared and uploaded to a common storage device or shared for public display via a video service such as youtube.com.

The Media Screen technology and its means for displaying media also applies to Personal Digital Assistants (PDAs), devices such as the “Blackberry,” and other handheld and pocket-sized computing and communication devices. In other words, a PDA device can be enabled with a Media Screen or screens for the purpose of media display, placement of an identifying marker, or other effort of display identification or personalization.

Another embodiment enables themes to be downloaded from the Internet instead of created directly by the user. For example, a computer manufacturer can supply several “prepackaged” themes for a particular computer configuration. Upon purchase, an initial “default” theme is installed. Utilizing the account management software, a user can select an alternative theme from a list provided by the manufacturer or a third party. After purchase, the manufacturer or third party can create new or updated themes, for example to reflect new ideas or events (a theme based on a new movie release perhaps). Since themes are made available via the Internet, they can be manually selected by the user or perhaps automatically downloaded and displayed on the device without direct user involvement. When automatically downloaded, a user setting may control the level of automatic theme selection provided, for example, choosing the frequency of updates, or a particular theme category (sports, science fiction, cartoons, etc) from which to choose when deploying a new theme.

In media device embodiments that include only a single display and no other functions, the existing multiple display support of modern computer operating systems may be utilized. The host computer would thus include both its primary display as well as the display of the media device. Modern operating systems such as Microsoft Windows 2000, XP, Vista, and Windows 7 also typically provide support for multi-function peripherals. Utilizing these capabilities, devices such as a printer with an integrated scanner, fax machine, and modem, or a sound oriented device including both speakers and a mass storage system for sound files are now easily supported. The disclosed media devices including multiple capabilities, such as the media keyboard which includes a keyboard and one or more displays, can interface to the operating system via these preexisting operating system capabilities.

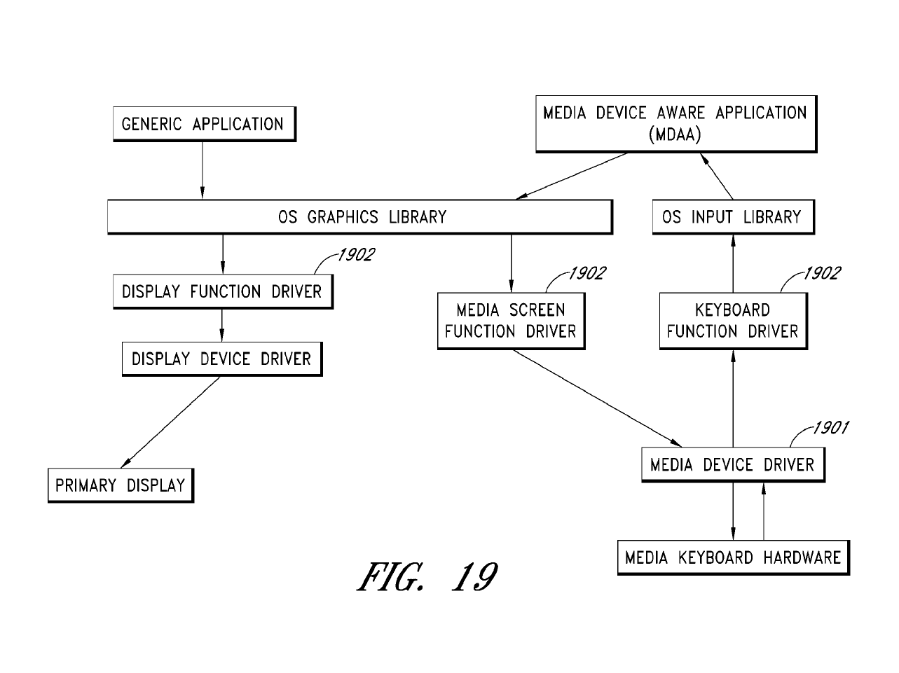

FIG. 19 depicts a typical software architecture enabling a computer configuration including a media display device. Note in this embodiment the media display is treated by the operating system as a typical computer display, albeit with different display dimensions compared to a traditional computer display. Also of note is the use of one device driver 1901 per physical device to provide communication with the physical device. One or more functional drivers 1902 are present for each device, depending on the number of functions each device incorporates. For example, with a media keyboard incorporating seven displays, the architecture would consist of eight function drivers (one for the keyboard, and one for each of the displays), but only one device driver, which manages communication with the physical media keyboard device itself. Such configurations are easily supported in the existing art. See for example, Windows Driver Model (WDM) or Windows Driver Foundation (WDF). See also the USB® specification at http://www.usb.org.

Multi display environments of typical operating systems such as Microsoft Windows also provide multiple operating modes. In one embodiment, the operating system can be configured in a “spanning” mode, where the media station display is treated as simply an extension of the display space available. In this embodiment, the display component of the media device appears as a traditional secondary display to the operating system. The traditional “desktop” of the host computer “spans” from the primary display to the media display(s). In spanning mode, traditional applications are unaware of the media display's presence yet still provide display capabilities to those devices simply via their position on the desktop. With the spanning mode embodiment, any application can provide media display capabilities. This embodiment provides an advantage of low cost support for an infinite array of content types, including traditional image files, streaming video, selected content from web sites, proprietary content of unknown format, etc, as long as an application is available to display that content. The disadvantage of this embodiment is the limited ability to customize the display based on the native features of the particular application utilized.

An alternative embodiment provides for applications that are media display aware and direct their output to a particular media station display or displays. This embodiment enables a very specific and customized display appearance not dependent on the generic applications used in the previous embodiment. In this new embodiment, the media display aware application (MDAA) identifies its specific output device/display via the operating system's graphics support API. For example, in Microsoft Windows, the GDI API supports this capability.

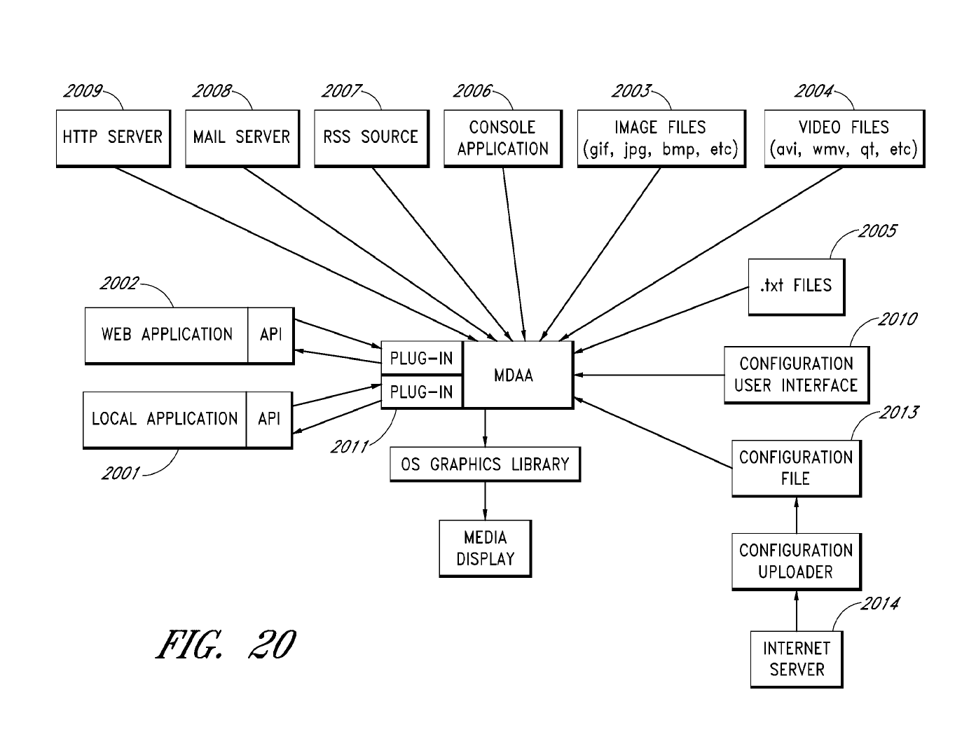

FIG. 20 describes one possible embodiment of an account management system, which is media display aware. (MDAA) The architecture depicted in FIG. 20 supports a variety of display content types and sources, including content generated by both local and web based applications. This MDAA provides native support for local content types such as known graphics and video file formats, as well as console application output. A console application can provide simple display output such as a quote of the day, or time of day information. The MDAA also provides native support for standard Internet content retrieval protocols such as RSS, HTTP, and POP3 (e-mail). To support content not accessible via a native, standard protocol, the MDAA provides a “plugin” API, enabling programmers to feed web application content accessible only via “non standard” means directly into the MDAA. This plugin architecture can be utilized to retrieve display content from both “web based” applications or local applications running on the host PC. This architecture also provides for future extensibility of the MDAA as Internet standards and content types continue to evolve.

In one embodiment, popular content providers such as Facebook, Twitter, eBay, CNN, or ESPN develop their own “plug-in” for the account management system. The plug-ins can also be developed by the media device manufacturers themselves or any third party with access to the content provider API. The plug-in enables display of content from the providers on the media device. The web-application can utilize widget technology or other Internet programming models to accomplish this function. As the Internet continues to evolve and new web applications gain popularity, new “plug-ins” can be developed to extend the media device display capabilities.

In one embodiment, the MDAA provides an interactive user interface (2010) to manage the configuration for the connected media displays. For example, if several media displays are connected, the user can select, via the MDAA user interface, which display source (files (2003) (2004) (2005), plug-ins (2011), rss feeds (2007), etc) should be displayed on each of the connected displays. Alternatively, display configuration is read by the MDAA from a configuration file (2013), thus enabling a fully automated configuration, useful in prepackaged products, which are typically customized without user involvement.

In another embodiment, display configuration is periodically updated via an Internet connection. The MDAA (either directly or via a helper application) contacts an Internet server (2014) maintained by the computer vendor or a 3rd party to retrieve updates. These updates may specify both the display content and its configuration (how the content is laid out across the hosts configured media displays). To facilitate the server's ability to generate an appropriate display configuration, the MDAA sends the local display configuration to the Internet server when requesting updates. The Internet server is then able to retrieve the appropriate update (including content and configuration) for the MDAA's specific display configuration. Display content can be specified via either inclusion of the content itself (in the form of image or video files), or via a URL the MDAA can utilize to retrieve the display content. Using this embodiment, the original computer vendor or their assigns can control the customized appearance of the display(s) long after the sales transaction is completed.

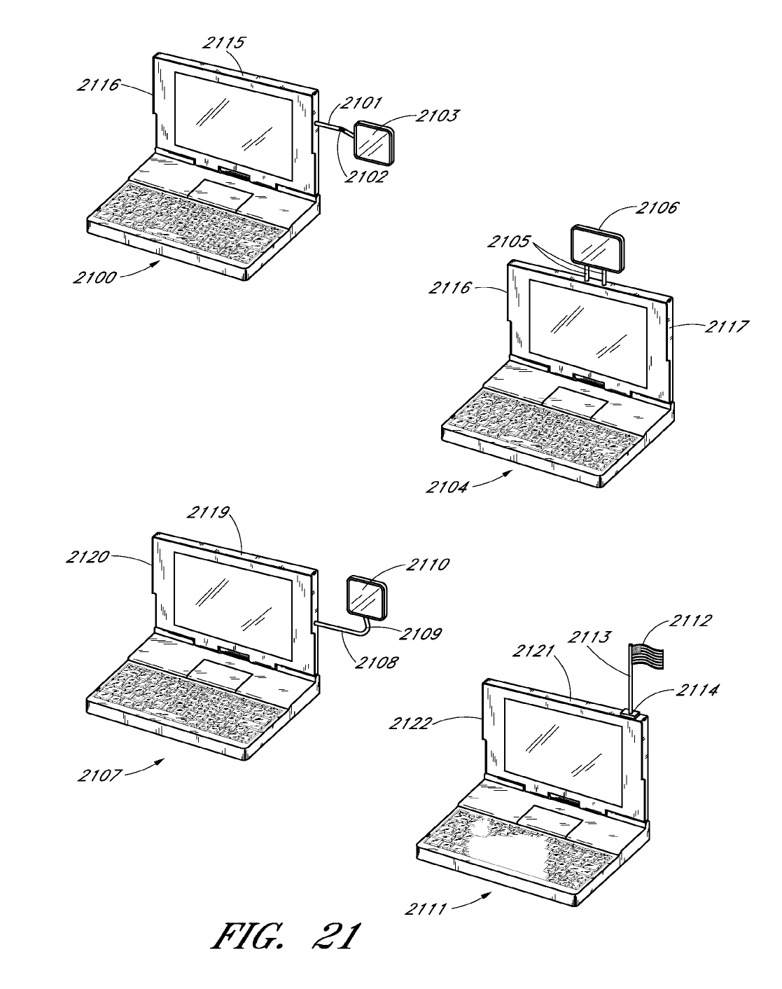

FIG. 21 describes several additional embodiments of a Media Screen. In the FIGURE, Media Screens may be attached to a laptop computer screen via a positioning member 2101, 2105, and 2108. The positioning member may also be referred to as a support member. When attached as shown in FIG. 21, the Media Screen can be fully functional. The positioning member may provide not only structural support for the media display, but also electrical and digital connectivity if so required. Note that Media Screens may be supplied with electrical power via batteries or a separate power cord. In such embodiments, electrical power is not provided by the positioning member. Digital connectivity for the Media Screen in this embodiment can also be provided via the positioning member, a separate wired connection, or via a wireless connection. Connectivity between the primary display and the positioning member may be provided via existing standards such as USB, but is not limited to only USB. In some cases, the weight of the display may require the electrical/digital connection utilized (such as USB) to be augmented with other mechanical means to ensure proper structural support. For example, additional clips or screws integrated into the positioning member or an associated connector to attach the Media Screen to the primary display. Such attachments may be referred to herein, for example, as an anchoring member or members.

In another embodiment, Media Screens can be attached to other displays not specifically associated with a laptop computer. For example, Media Screens could be configured similarly to the method of FIG. 21 but instead attached to the display of a “desktop” personal computer, or the administrative station of a copier or other large electronic machine or base of a device such as a Media Mate. A Media Screen or screens can also attach to instrumentation devices, for example oscilloscopes, protocol analyzers, etc. Media Screens might also attach to digital television sets or set-top boxes (for example those provided by cable providers to deliver additional flexibility in the television viewing experience or for television content providers to offer additional content to viewers without utilizing valuable primary screen area.

Note that a media display may be attached to a primary screen by more than one positioning member. For example, the weight of the Media Screen may require more support than is possible with only one connector. This is the case in embodiment 2104, with multiple positioning members present (2105). While only two positioning members are shown in this embodiment, more are possible, including embodiments including three, four, five, six, seven, etc positioning members. Devices can have at least one post to connect it to the primary display and also have at least one perpendicular post or positioning/support member attached to a base or anchor element that connects to the computing device. The Media Screen can also be attached on the sides 2117 and 2118 of the computing device. Image 2107 shows a Media Screen 2110 with yet another different type of support/connection apparatus 2108. This demonstrates that there are many interchangeable elements to the ways Media Screens can be connected to portable computing devices. The Media Screen 2110 can also be attached in other locations on the device such as 2119 and 2120.

In some embodiments, the positioning member may include an integrated hinge or flexible joint (2102, 2109), allowing the Media Screen to be positioned at various angles relative to the primary display for the user's convenience. Alternatively, positioning members can make use of “gooseneck” technology, telescoping technology, or other technology to provide flexibility so that the Media Screen can be positioned at various distances and angles from the primary display. The display, support member, and connector may rotate or be adjustable relative to each other.

The extension support apparatus as a connection to the computer can be of any reasonable length from flush to the connection with the frame of the computing device to 10 inches in length. It can be rigid, bendable, angled, telescopic and/or have at least one hinge or joint element in some embodiments. The Media Screen 2103 can also attach via a USB type connection on top of the open clamshell 2115, or on the other side 2116.

Image 2111 shows yet another embodiment of a Media Screen 2112 that resembles an American Flag. It could be any design, naturally, and it is supported by a connection to the primary display by an apparatus that features a base 2114 and a single perpendicular pole-type piece 2113. The location on the primary display can also vary. For example, the connection can be located in 2121 and/or 2122. In all embodiments, there can be multiple points of connection that deliver power such as a USB and also structural support. This type of Media Screen connectivity can also apply to handhelds and PDAs in some embodiments.

Some embodiments of devices may include, for example, coupling attachments that recharge popular devices such as MP3 players, cell phones and/or devices that are sometimes referred to as “smart phones” or “smartphones,” such as the iPhone®, Blackberry®, Android® and other similar devices or classes of devices, including “tablet” type devices such as the iPad®. For example, some embodiments can include a Media Mouse embodiment that has a cavity in which an iPhone®, or similar device, slides into and attaches or connects via a coupling attachment mechanism in order to recharge the iPhone® (or similar device) while the Media Mouse executes the normal tasks associated with a computer mouse. In another example, a Media Mouse can be configured to recharge an iPod® (or similar device) while still performing the normal tasks associated with a mouse. Further, the aforementioned embodiments that charge the iPhone® (or similar device) and/or iPod® (or similar device) also may enable normal use of said recharging devices while they are recharging. For example, there can be a speaker on a peripheral such as a Media Mouse that played the iPod® while charging it. In another example, the PC system to which the Media Mouse is attached can play the iPod® on its own audio system while it charges via the peripheral. In other words, while the iPhone® (or similar device) recharges, the applications of said recharging device, such as the touch screen, text or phone communication capabilities, can be used simultaneous to the device being recharged by the embodiment of the peripheral as said peripheral executes its associated tasks as described elsewhere herein, i.e. the Media Mouse, Media Keyboard, Media Monitor, MediaBook or other related computing applications. The coupling attachment, and/or communication interface that facilitate a system recharge to the targeted recharging device from the source embodiment of the peripheral or MediaBook, can be of any appropriate configuration, including a universal configuration that applies to any and all known recharging mechanisms. Furthermore, Media Keyboards, Media Monitors, MediaBooks, Media Mates and all other described embodiments can also feature the recharging technology, where a slot, cavity, coupling attachment member, extension wire or cord or any type of connecting or communicating interface, including charging stations, Power Mats and similar devices, is/are integrated into the architecture and/or design of the peripheral. Also, the recharging capability can be an option on a device, where the recharging capability is not the primary purpose of the device. For example, a Media Mate shaped like a TV set can deliver Media Screen functionality while having a docking station, connection point or similar outlet that enable recharging a multiplicity of devices in addition to offering the Media Screen capabilities described elsewhere herein.

Certain embodiments of the various peripherals can include one or more of outlets, interfaces and/or USB connections of all shapes, sizes and design formats to power, recharge and/or otherwise connect to another device for any useful purpose. Additionally, any of devices such as embodiments of the Media Keyboard, Media Monitor, MediaBook, Media Mate and Media Mouse can be configured to ergonomically and aesthetically integrate with any other device via a cavity, chamber, slot or intentional design such as a shallow depression on the exterior of said embodiment(s) that facilitates integration with another device. Further, some embodiments of devices with recharging and usage capabilities can be integrated to create peripherals with an association to known commercial licenses, promotional partners, and artistic design interpretations to known forms such as animals, vegetables, buildings, cars, consumer products, landscapes of nature, civil engineering designs, caricature work and other creative applications of said technology.

Other embodiments of the various peripherals, such as the Media Mouse, Media Mate, Media Keyboard, Media Monitor and MediaBook, can be designed and manufactured so that the devices have a section or sections that flip open or closed, that slide open or closed or that fold and unfold to deploy Media Screens. In some embodiments featuring an unfolding or deployable Media Screen, the device can have extension members that are attached to a Media Screen, where said extension members can be made of metal, plastic or any other suitable material or any combination of suitable materials, and where the extension members or rods hinge via a mechanism and move in one direction to open/unfold and reveal a Media Screen or screens for the purpose of media display and then later fold to contract/close the Media Screen and conceal said screen. For example, a Media Mouse could feature a top section that fits flush against another section, a lower or bottom section, where said top section is connected on opposing sides to hinges located on the device via an extension member or extension members or rods that are affixed to the top section via glue, screws, pins or other connective method where said top section can rotate, flip up or otherwise open into an exposed or open position revealing a Media Screen that can be of a fixed or adjustable angle to the user. Once in that open position, the Media Screen can be viewed by a user/operator in a manner consistent with other ways described herein. The top section can be similarly closed, by reversing the process that opened the top section. The opening and closing mechanism is not limited to a hinge technology. The sections can open and close via gears, snaps, springs, pins, tension systems or other suitable technologies. These embodiments can be of any suitable shape and size to accommodate the desired functionality of both the peripheral and the added display capability that is represented by the presence of a Media Screen and the additional accommodation of the opening and closing aspects of the device to reveal/use the Media Screen in the open/deployed state and to store in the concealed/retracted state. Some embodiments of all of the devices can feature a Media Screen that can be completely hidden, or closed in one aspect, and then opened or deployed to reveal the Media Screen in another aspect. Other embodiments can feature partially concealed Media Screens.

The ability to deploy/reveal and retract/conceal the Media Screen is not limited to a “top” and “bottom” configuration, where the Media Screen unfolds or deploys from the top of an embodiment of the device. Media Screens can unfold, or deploy, from any side or position on any type of device, whether it be a Media Mouse, Media Mate, Media Keyboard, Media Monitor or MediaBook. The unfolding, or deploying, of a Media Screen or screens can be supported by one, two, three or more rods, connection or extension members that connect the Media Screen to a hinging, or similar, mechanism on the device that permits the Media Screen to deploy/unfold for use as well as retract/fold to a storage position. The unfolding action can also be a mechanism that activates the Media Screen display capability for use and the Media Screen or screens can also have touch use capabilities. As noted elsewhere, the ability to deploy/reveal and retract/conceal the Media Screen is not limited to a hinging and unfolding of the Media Screen but also includes the ability to slide the Media Screen into a cavity of the target device such as a Media Mouse, Media Keyboard, Media Monitor, Media Mate and/or MediaBook and then slide or project it outwards from said cavity for the purpose of display. In some embodiments where the Media Screen can be retracted into and deployed from a cavity, the Media Screen can be on a hinge or hinge-type lever where it can then be rotated after being deployed for more advantageous viewing. Other activation methods for a Media Screen can include a button, spring, pin and rod, clasp, gearing mechanism or some type of tension system and in some aspects could be deployed by a computer command in a software derived application, remote command/keystroke or remote button.

Other applications of the Media Screen can apply to hand held devices ranging from tablets such as the iPad® or Kindle® to smart phones such as the iPhone® and related items in similar categories. One application, for example, would be attaching a Media Screen directly to an iPhone® (or similar device) so that the mobile phone now had the benefit of an extra display capability via a connecting point that can be a source of power for said Media Screen. Media Screen applications can also be like a billboard placed on top or a side of the device. Additionally, it can communicate remotely via an application (AKA “App”) or via a connective cable or wire.

Media Screens on any embodiment of the Media Mate, Media Mouse, Media Keyboard, Media Monitor, MediaBook and other applications of the technology can feature the touch screen capabilities that are available on many existing consumer products such as mobile phones, smart phones and tablets. Additionally, specific peripherals and software applications can be devised with this touch screen technology in mind, where the extra Media Screen allows unique interactivity capabilities in both information and consumer applications. For example, some aspects relate to applications configured or designed to enable studying and/or test taking and/or purchasing decisions and/or promotional offers and responses where the application and/or its target device, such as a Media Mate, Media Mouse, Media Monitor, Media Keyboard, MediaBook or attachment Media Screen, can leverage the touch screen technology to help a user interact in any type of application, such as studying, submitting an opinion, purchasing an item and/or enabling, finalizing, completing or conducting any type of consumer or correspondence activity. Further, any or all devices can be also have an operating system or platform that is open source and allows for convenient application development by outside vendors, individuals, companies, licensors and any combination thereof. Additionally, specific proprietary development of both devices and applications can leverage some of the technology described herein. For example, a company like Disney could take one of its brands such as ESPN and make a branded device such as a Media Mouse where polling, promotional offers, consumer offers, specialized content and unique user configurations can be integrated or developed across specific platforms that could include a promotional partner such as the NFL, Nike, Coca-Cola, IBM and/or any other for-profit or not-for-profit entity, including charitable concerns. Interactivity on devices also may include payment capabilities where credit card issuers, banks, payment services such as PayPal, or website specific checkout systems, e.g. Amazon, integrate payment applications into a Media Mate, Media Mouse, Media Monitor, MediaBook or Media Keyboard. In other words, some embodiments of various devices relate to devices that can be uniquely configured for debiting and crediting accounts via specific applications that can involve proprietary or non-proprietary features and technology including, but not limited to, touch screen recognition and/or any other application identifiers that can enable said transactions effectively and securely.

As noted elsewhere, Media Screens can be added to external connectivity points on any type of device such as a Media Mate, Media Mouse, Media Monitor, Media Keyboard, MediaBook, Personal Computer or Smart Phone where said Media Screen can be directly affixed to a connection point on any or all of the devices. Media Screens can also be connected via a wire, cable or other wireless communication mechanism where an application runs that leverages the interactivity between the Media Screen and its host device. In other words, in some embodiments, the devices can be connected, but separate and in other aspects, separate but connected, meaning that an additional Media Screen or screens, in any embodiment of a device, can interact with a computer and/or aspect of a computer via a connective physical element or connective wireless element where said connection between the devices can be via direct attachment at a connection point, via a wire, cable or other similar connective element, or a remote wireless communication technology such as Bluetooth®.

Embodiments of any Media Mouse, Media Keyboard, Media Mate, MediaBook or application of a Media Screen can be configured and manufactured in large sizes to accommodate those who might want a larger device. In such embodiments, the possibilities of shape, design and material composition are consistent with other descriptions herein, but the dimensions are larger and can be anywhere from one inch to seventy two inches in length, width and or height. Some embodiments of any of the devices may be designed for personal, promotional, commercial or industrial use.

The herein described subject matter sometimes illustrates different components contained within, or connected with, different other components. It is to be understood that such depicted architectures are merely exemplary, and that in fact many other architectures can be implemented which achieve the same functionality. In a conceptual sense, any arrangement of components to achieve the same functionality is effectively “associated” such that the desired functionality is achieved. Hence, any two components herein combined to achieve a particular functionality can be seen as “associated with” each other such that the desired functionality is achieved, irrespective of architectures or intermedial components. Likewise, any two components so associated can also be viewed as being “operably connected”, or “operably coupled”, to each other to achieve the desired functionality, and any two components capable of being so associated can also be viewed as being “operably couplable”, to each other to achieve the desired functionality. Specific examples of operably couplable include but are not limited to physically mateable and/or physically interacting components.

With respect to the use of substantially any plural and/or singular terms herein, those having skill in the art can translate from the plural to the singular and/or from the singular to the plural as is appropriate to the context and/or application. The various singular/plural permutations may be expressly set forth herein for sake of clarity.

It will be understood by those within the art that, in general, terms used herein, and especially in the appended claims (e.g., bodies of the appended claims) are generally intended as “open” terms (e.g., the term “including” should be interpreted as “including but not limited to,” the term “having” should be interpreted as “having at least,” the term “includes” should be interpreted as “includes but is not limited to,” etc.). It will be further understood by those within the art that if a specific number of an introduced claim recitation is intended, such an intent will be explicitly recited in the claim, and in the absence of such recitation no such intent is present. For example, as an aid to understanding, the following appended claims may contain usage of the introductory phrases “at least one” and “one or more” to introduce claim recitations. However, the use of such phrases should not be construed to imply that the introduction of a claim recitation by the indefinite articles “a” or “an” limits any particular claim containing such introduced claim recitation to embodiments containing only one such recitation, even when the same claim includes the introductory phrases “one or more” or “at least one” and indefinite articles such as “a” or “an” (e.g., “a” and/or “an” should typically be interpreted to mean “at least one” or “one or more”); the same holds true for the use of definite articles used to introduce claim recitations. In addition, even if a specific number of an introduced claim recitation is explicitly recited, those skilled in the art will recognize that such recitation should typically be interpreted to mean at least the recited number (e.g., the bare recitation of “two recitations,” without other modifiers, typically means at least two recitations, or two or more recitations). Furthermore, in those instances where a convention analogous to “at least one of A, B, and C, etc.” is used, in general such a construction is intended in the sense one having skill in the art would understand the convention (e.g., “a system having at least one of A, B, and C” would include but not be limited to systems that have A alone, B alone, C alone, A and B together, A and C together, B and C together, and/or A, B, and C together, etc.). In those instances where a convention analogous to “at least one of A, B, or C, etc.” is used, in general such a construction is intended in the sense one having skill in the art would understand the convention (e.g., “a system having at least one of A, B, or C” would include but not be limited to systems that have A alone, B alone, C alone, A and B together, A and C together, B and C together, and/or A, B, and C together, etc.). It will be further understood by those within the art that virtually any disjunctive word and/or phrase presenting two or more alternative terms, whether in the description, claims, or drawings, should be understood to contemplate the possibilities of including one of the terms, either of the terms, or both terms. For example, the phrase “A or B” will be understood to include the possibilities of “A” or “B” or “A and B.”

While various aspects and embodiments have been disclosed herein, other aspects and embodiments will be apparent to those skilled in the art. The various aspects and embodiments disclosed herein are for purposes of illustration and are not intended to be limiting, with the true scope and spirit being indicated by the following claims.

While the above detailed description has shown, described and pointed out novel features of the invention as applied to various embodiments, it will be understood that various omissions, substitutions, and changes in the form and details of the device or process illustrated may be made by those skilled in the art without departing from the spirit of the invention. Further, many variations on the theme have yet to been conjured, and, as will be recognized, the present invention may be embodied within a form that does not provide all of the features and benefits set forth herein, as some features may be used or practiced separately from others.

1-87. (canceled)

88. A secondary display device for use with a primary display on a computer, the secondary display device comprising: a display; a positioning member coupled to the display; and a connector, coupled to the positioning member, the connector configured to connect to a corresponding connector disposed on a housing of a primary display on a computer in order to have more than one display for use with the computer.

89. The device of claim 88, wherein the positioning member is configured to extend telescopically.

90. The device of claim 88, wherein the positioning member is configured to rotate.

91. The device of claim 88, wherein the positioning member is deformable.

92. The device of claim 88, wherein the positioning member comprises one or more joints.

93. The device of claim 88, wherein the secondary display is configured to rotate relative to the positioning member.

94. The device of claim 88, wherein the connector comprises an anchor configured to support the weight of the display and the positioning member.

95. The device of claim 88, wherein the connector comprises a USB connector.

96. The device of claim 88, wherein the secondary display is configured to interact with the computer, the secondary display further comprising: a memory, wherein the memory is configured to store a display content; and, a processor coupled to the secondary display and to the memory, wherein the processor is configured to output content to the secondary display.

97. The device of claim 88, wherein the connector is configured to attach to the perimeter of a display region of a laptop, netbook, mini, PDA, handheld or to the perimeter of a primary display of a desktop computer.
